(19) United States
(12) Patent Application Publication
(10) Pub. No.: US 2014/0075310 A1
(43) Pub. Date: Mar. 13, 2014

(54) Method and Apparatus For creating user-defined media program excerpts

(71) Applicant: ERIC LI, Dallas, TX (US)

(72) Inventor: ERIC LI, Dallas, TX (US)

(21) Appl. No.: 13/610,301

(22) Filed: Sep. 11, 2012

(51) Int. Cl. G06F 3/01

(52) U.S. Cl. 715/716

(57) ABSTRACT

The present disclosure involves a method of managing media playback. The method includes: playing a media program via an electronic device; receiving, during the playing of the media program, a first input that defines a beginning of a user-defined excerpt of the media program; receiving, during the playing of the media program, and after the beginning of the user-defined excerpt of the media program has been defined, a second input that defines an end of the user-defined excerpt of the media program; associating the user-defined excerpt of the media program with an account of a user; and thereafter displaying an availability of the user-defined excerpt of the media program.

### BACKGROUND

1. Technical Field

The present disclosure generally relates to managing and displaying media content.

2. Related Art

Traditionally, consumers have been consuming media content such as movies (or other types of videos) by going to a movie theater or by watching media programs on television (TV). For example, a consumer may rent or buy a movie on a cassette tape or a DVD disk and then play the movie on TV using a video cassette player or a DVD player.

In recent years, the rapid advances in computer technology and broadband telecommunications have enabled media content to be played on electronic devices such as laptops, tablet computers, or mobile telephones. For example, a consumer can download a movie to his/her electronic device and subsequently play the movie on the electronic device. As another example, the consumer can also watch the movie by wirelessly streaming the movie to his/her electronic device from a remote computer server. These new ways of consuming media content on electronic devices offer convenience and simplicity for the consumers.

Nevertheless, existing methods and apparatuses for managing and playing media content via electronic device still have drawbacks. For example, existing media content management and playback systems may not offer a user an intuitive and versatile way to manage his/her media content collection or to customize his/her media content collection according to his/her own preferences.

Therefore, while existing methods and apparatuses for managing and playing digital media content electronically have been generally adequate for their intended purposes, they have not been entirely satisfactory in every aspect. It would be advantageous to add more intuitive and versatile content management and playback capabilities to a media system.

### BRIEF DESCRIPTION OF THE DRAWINGS

FIGS. 1-13 are example screen shots of various embodiments of user interfaces for managing and playing media programs according to various aspects of the present disclosure.

FIG. 14 is a simplified block diagram of an example electronic device for managing and playing media programs according to various aspects of the present disclosure.

FIGS. 15-16 are simplified block diagrams of various embodiments of a system for managing and playing media programs according to various aspects of the present disclosure.

FIGS. 17-19 are example methods for managing and playing media programs according to various aspects of the present disclosure

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity. In addition, the present disclosure may repeat reference numerals and/or letters in the various examples. This repetition is for the purpose of simplicity and clarity and does not in itself dictate a relationship between the various embodiments and/or configurations discussed

Consumers have traditionally been consuming media content by watching TV or by going to movie theaters. Recently, rapid advances in computer technology and broadband telecommunications have enabled media content to be consumed on electronic devices such as laptops, tablet computers, or mobile telephones. For example, a consumer can download a media program such as a movie to his/her electronic device and subsequently play the movie on the electronic device. As another example, the consumer can also watch the movie by wirelessly streaming the movie to his/her electronic device from a remote computer server. These new ways of consuming media content on electronic devices offer convenience for the consumer (also interchangeably referred to as a user thereafter).

Nevertheless, existing methods and apparatuses for managing and playing media content via electronic devices still have drawbacks. One such drawback is that they may not offer sufficient media management or control functionalities for a user. For example, they may not offer a user an intuitive, quick, and versatile way to manage his/her media content collection or to customize his/her media content collection according to his/her own preferences.

According to the various aspects of the present disclosure, various methods and apparatuses for improving media content management and playback are disclosed, as discussed in more detail below.

For many users, they may enjoy certain parts of a media program more than the rest of the media program. As one example, a user may particularly enjoy a battle scene from a movie. As another example, a user may particularly enjoy a dialog between two or more characters from a movie. Yet as another example, a user may particularly enjoy a certain part of a song. In many instances, the parts of the media program that the user particularly likes may not be very long, for example they may be only a few minutes in length.

However, existing media management and playback systems do not offer an easy and flexible way for a user to quickly locate these favorite parts of a media program for a user. For example, a user may have to tediously fast-forward through many scenes he/she does not care to watch just in order to get to the scene that he/she does wish to watch. This is even more true if it has been a while since the user has last viewed the media program and has therefore forgotten where his/her favorite scene is located. Consequently, the user may even need to spend more time trying to find the location of his/her favorite scene within the media program. This searching process wastes time and resources and may lead to a frustrating media consumption experience for the user.

According to the present disclosure, an improved media management and playback system is disclosed, which allows users to create or define their favorite excerpts from media programs and thereafter quickly locate them for almost instant media playback.

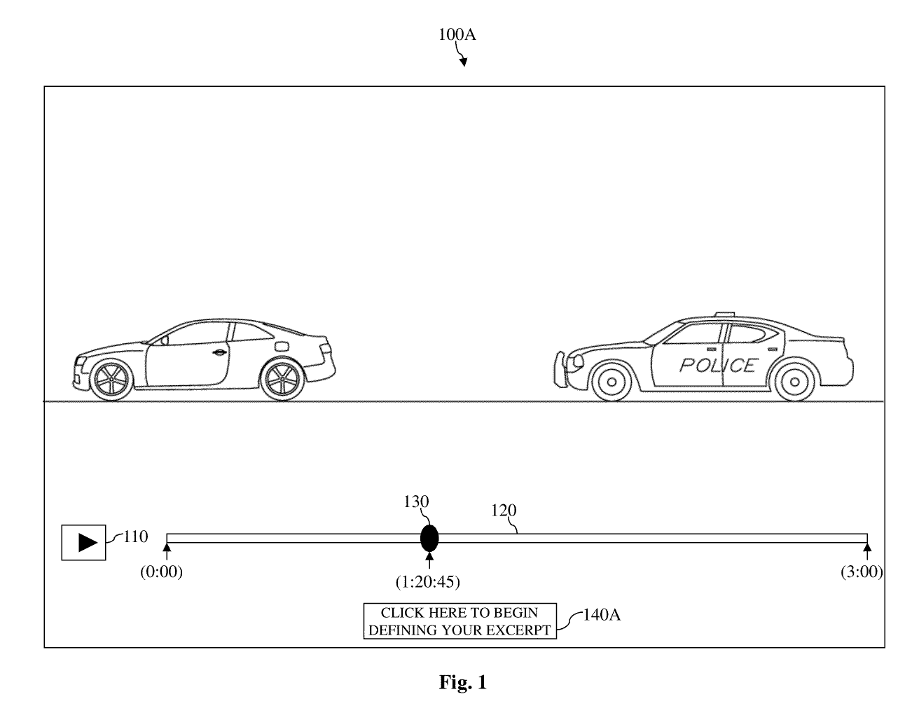

FIGS. 1-4 are various screenshots of a user interface 100A illustrating the creation of a user-defined favorite excerpt in a media program. In the illustrated embodiments, the media program is being played on an electronic device. The electronic device may be a desktop computer, a laptop computer, a tablet computer (for example, APPLE's® IPAD® or various ANDROID® or WINDOWS® powered tablets), a mobile telephone (for example, APPLE's® IPHONE® or various ANDROID® or WINDOWS® powered smart-phones), or a television (TV) set with an external or integrated set-top box.

In some embodiments, the electronic device may include a touch-sensitive display (or touch screen) via which the media program may be played. However, it is understood that the various aspects of the present disclosure may apply to a non-touch screen display as well. For example, whereas a touch screen device may detect user input via sensing the contact and the movement of the user's fingers on the touch screen, a non-touch screen device may detect user input via more traditional mechanisms such as a mouse, a keyboard, a remote control, a gesture, or voice commands.

In various embodiments, the media program may include movies, TV shows, documentaries, music videos, podcasts, soundtracks, educational programs, sporting events, artistic performances, or any other type of suitable audio/video digital file that can be played on the electronic device. In some embodiments, the consumer or user may download the media program to the electronic device from a remote server hosted/owned/operated by a media service provider or partner of the media service provider. For example, the media program may be downloaded from APPLE's® ITUNES®, THE APP STORE® from APPLE®, ANDROID's® PLAY STORE®, AMAZON's® INSTANT VIDEO® store, MICROSOFT's® WINDOWS STORE®, RESEARCH UN MOTION's® APP WORLD®, or from a suitable media download service from another media content provider. After the media program is downloaded to a local storage of the electronic device, the user may then play the media program on the electronic device.

In some other embodiments, the user may stream the media program from a remote computer server without having to download the media program in its entirety. For example, service providers such as NETFLIX®, AMAZON®, HULU®, COMCAST®, VUDU®, and REDBOX® may each offer various types of video streaming services for their subscribing members. A user who is a member of these services may log on to the web site (or launch an “app”) of the service provider and thereafter select a desired media program to be played. A play request from the user may be then sent to the remote server of the service provider, for example over a suitable wired or wireless telecommunications protocol. After verifying the user's identity and account information, the service provider may then allow the user to stream the media program by continuously sending digital packets to an electronic device of the user over the suitable telecommunications protocol. In some embodiments, this type of media content streaming may allow the electronic device to build up a “buffer” on a local storage of the electronic device, where the buffer may include a portion of the media program. The media program streaming may then be done by retrieving digital content from the buffer, which may be constantly updated.

In yet other embodiments, the user may acquire the media program by digitally converting a legally-owned copy of the media program to a digital file that can be stored on the electronic device. For example, the user may use a computer software program to convert a legally-owned DVD copy of a movie into a digital file, and then transfer the digital file of the movie onto the local storage of the electronic device. Similarly, the user may “rip” the songs from a music CD to a plurality of digital music files and then transfer these digital music files to the local storage of the electronic device.

Referring to FIG. 1, a screenshot of a user interface 100A for managing and playing a media program is shown. The user interface 100A displays a scene from a media program (for example a movie) on an electronic device discussed above (e.g., desktop, laptop, tablet, smart-phone, TV, etc.). The interface 100A may contain virtual on-screen controls such as a play/pause button 110, a scroll bar 120, and a position indicator 130 (e.g., in the form of a cursor). In some embodiments, these virtual on-screen controls are displayed as the media program is being played. In other embodiments, the display of these virtual on-screen controls can be normally hidden, but their display may be triggered by an appropriate user input. Such user input may be gesture-based, such as a user's tap on the touch screen of the electronic device. Such user input may also be action-based, such as a click of a mouse on the screen. Such user input may also be voice-based, for example via a suitable voice command from the user.

The play/pause button 110 may be used to play or pause the media program. The scroll bar 120 and the position indicator 130 may be collectively used to perform navigational tasks through the media program. In more detail, the length of the scroll bar 120 may represent a total duration of the media program (for example, 3 hours for a 3-hour movie). The location of the position indicator 130 on the scroll bar 120 indicates a time location of the present scene of the media program being displayed (with respect to the media program as a whole).

The indicator 130 may be moved along the scroll bar 120 in a left direction or a right direction to accomplish certain navigational tasks. For example, a movement of the indicator 130 in the left direction results in a rewinding of the media program, whereas a movement of the indicator 130 in the right direction results in a fast forwarding of the media program. The movement of the position indicator 130 may be accomplished by a user gesture, for example a user using his/her finger(s) to “drag” the indicator 130 to various locations along the scroll bar 120. Although not specifically illustrated for reasons of simplicity, the interface 100A may also contain other virtual on-screen controls such as volume controls, subtitle displays, mute/unmute, screen resizing, exit media playback, etc.

In some embodiments, the user interface 100A also includes a virtual button 140A that allows the user to define one or more of his/her favorite excerpts. For example, the button 140A may display a message “click here to begin defining your excerpt” or some other similar message. The message is clear enough for the user to intuitively understand that a click of the button 140A will mark the beginning of a user-defined favorite scene or excerpt. In some embodiments, the button 140A is normally hidden as the user is watching the media program. In those embodiments, the appearance of the button 140A may be triggered by a user gesture, for example by the user tapping on the touch screen display once or twice (or a plurality of times). Alternatively, the user gesture may include the user drawing a predefined pattern on the touch screen display, or by the user pressing down on the play/pause button 110 or the position indicator 130 for a few seconds, or by the user going through one or more menu items (not shown herein). In some other embodiments, the appearance of the button 140A may also be triggered by one or more of the user's voice commands. Also, in embodiments where a touch screen display is not involved, the appearance of the button 140A may also be triggered by other suitable mechanisms such as a click of a mouse, a stroke of a keyboard key, or by a click of a button on a remote control (for example a remote control for a TV). It is also envisioned that the button 140A may be constantly displayed on the screen without needing a user input trigger in certain embodiments.

Once the user engages the button 140A, a first signal is sent to a media program management and playback system that manages and plays of media program. In some embodiments, the media program management and playback system may include or more computer servers of a media program service provider, such as NETFLIX®, AMAZON®, APPLE®, HULU®, COMCAST®, VUDU®, and REDBOX® discussed above. These computer servers may be configured to electronically stream the media program to the electronic device on which the user is watching. In other embodiments, the media program management and playback system may include one or more computers of the user, which may even include the electronic device itself on which the media program is being played. In other words, the user may be watching the media program locally without having to stream it from a remote source.

In any case, the media management and playback system has an electronic communications interface that receives the first signal indicating that the user has engaged the button 140A. The first signal may also include information indicating at what time during the playback of the media program the button 140A is engaged. For example, in the embodiment shown, the user pressed the button 140A to begin defining his/her favorite excerpt at 1 hour and 20 minutes and 45 seconds into the movie. The media management and playback system has one or more electronic processors that analyzes the first signal, extracts the time information, and therefore “knows” that the user wishes to mark the beginning of his/her favorite excerpt for this particular media program being played at 1 hour 20 minutes and 45 seconds into the movie.

The media management and playback system may then record this information in association with the media program and link it to an account of the user. For example, the media management and playback system may record (e.g., as a database entry) that the user A has defined a beginning of a favorite excerpt for the movie “Example Movie M” at 1 hour 20 minutes and 45 seconds into the movie. Based on the above example, this information pertains only to the user A and the movie “Example Movie M” and is not associated with other users or even other movies in user A's account.

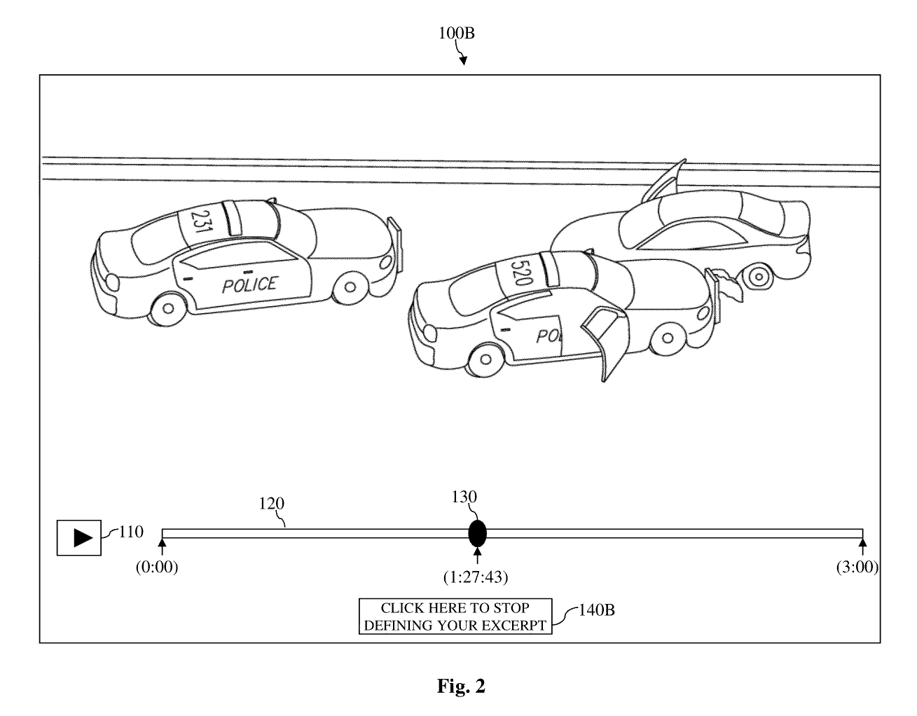

Referring now to FIG. 2, as the scene(s) of the media program continues to progress, eventually the user may wish to complete the definition of his/her favorite excerpt. In other words, the user now wishes to mark an end to the user-defined favorite scene or excerpt for the particular media program. To accomplish this task, the virtual button 140A automatically changes into a virtual button 140B once the user engages it. The button 140B may read, as an example, “click here to stop defining your excerpt” or another similar message to let the user know that he/she may end the user-defined excerpt by engaging the button 140B. In this example, once the user clicks on the button 140B, a second signal is sent to the media management and playback system discussed above (which may be either remote or local). Similar to the first signal, this second signal may also contain time information indicating at what time during the playback of the media program the button 140B is engaged. For example, in the embodiment shown, the user pressed the button 140B to complete the definition of his/her favorite excerpt at 1 hour and 27 minutes and 43 seconds into the movie. The media management and playback system may analyze the second signal to determine that the user wishes to mark the end of his/her favorite excerpt for this particular media program being played at 1 hour 27 minutes and 43 seconds into the movie.

It is understood that the user does not actually need to wait for the media program to naturally progress to the end point. He/she may instead move the position indicator manually to a time location (after the beginning location of the excerpt) of the media program to mark the end location of the excerpt. This is beneficial when the user already knows ahead of time where the end of the excerpt should be defined (or close to it). To facilitate the performance of this task, the user may take advantage of a “zoomed-in” scrolling feature as disclosed in U.S. patent application Ser. No. 13/485,308, filed on May 31, 2012, titled “Method and Apparatus For Enhanced Media Playback Control,” the contents of which are hereby incorporated by reference in their entirety.

In any case, the media management and playback system may then record this information in the second signal in association with the media program and link it to an account of the user. For example, the media management and playback system may record (e.g., as a database entry) that the user A has defined an end of a favorite excerpt for the movie “Example Movie M” at 1 hour 27 minutes and 43 seconds into the movie. Once again, this information pertains only to the user A and the movie “Example Movie M” and is not associated with other users or even other movies associated with the user A's account.

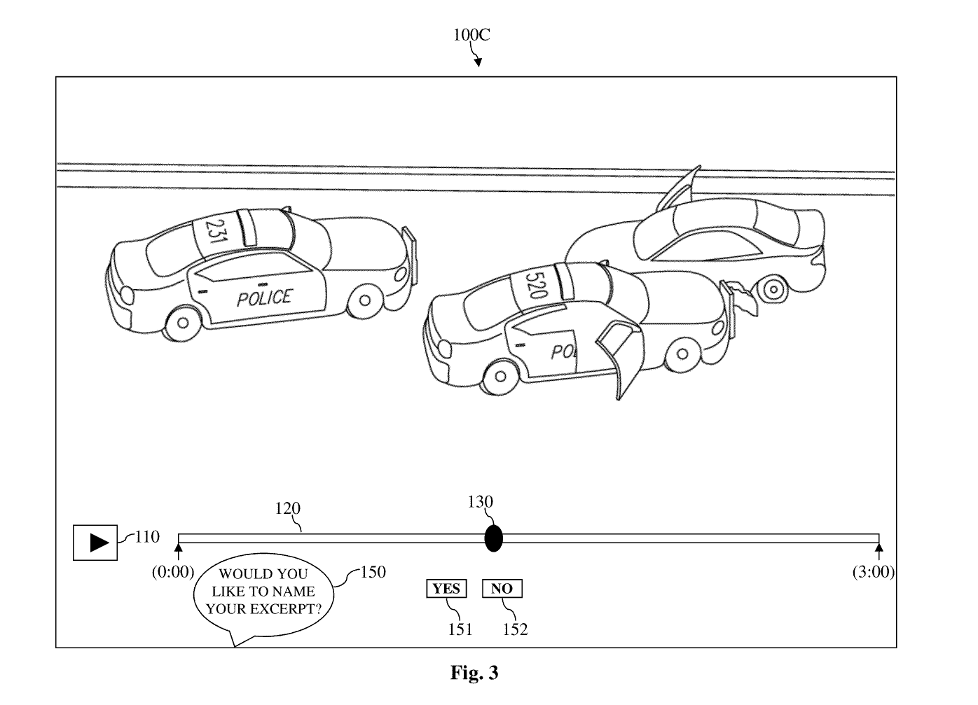

Referring now to FIG. 3, in some embodiments, once the user has defined the end of this user-defined excerpt, the user interface 100C may display a message 150 asking the user whether or not he/she would like to name the excerpt. The message 150 may read, for example “would you like to name your excerpt?” The user interface 100C may also display a “YES” button 151 and a “NO” button 152 to record the user's selection. If the user wishes to name the user-defined media program excerpt by clicking the “YES” button 151, the user interface 100 may then prompt the user to enter a name for his/her excerpt. In some embodiments, a virtual keyboard may automatically be displayed on screen to let the user input the name of the excerpt. In other embodiments, the user may dictate the name of the excerpt through voice control. On the other hand, if the user does not wish to name the user-defined media program excerpt at this time, the user interface may resume playing the media program. A default name will automatically be assigned for the user-defined excerpt, for example “Excerpt 1” or something similar. For reasons of simplicity, the user's naming or automatically assigning a name for the user-defined media program excerpt is not specifically illustrated herein.

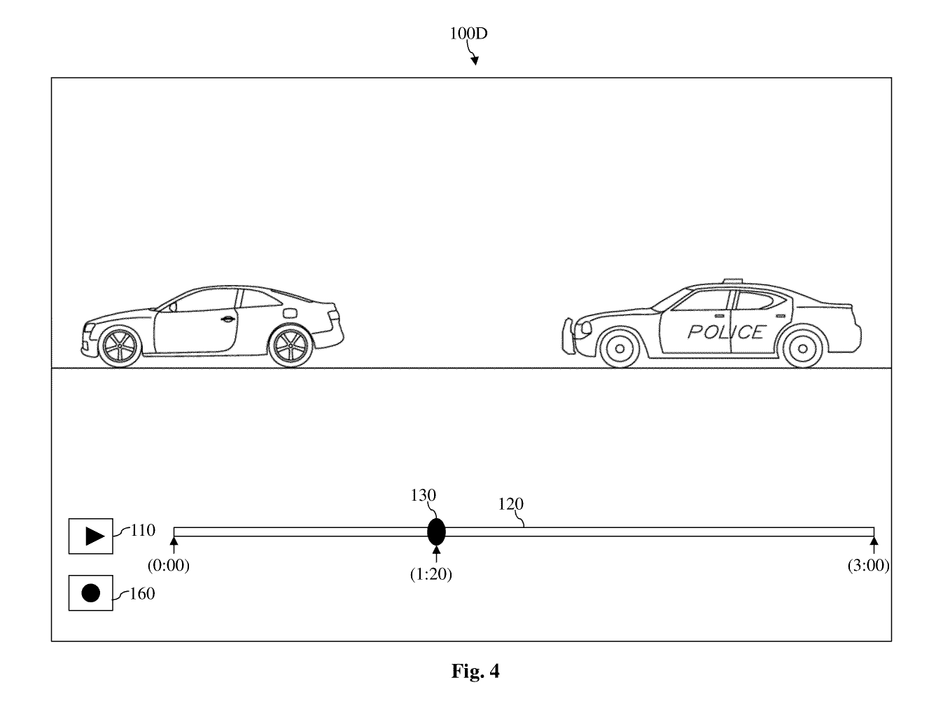

Though the example discussed above utilizes virtual buttons 140A-140B to facilitate the user's definition of a favorite media program excerpt, it is understood that the buttons 140A-140B are merely example mechanisms, and that different on-screen (or off-screen) mechanisms may be utilized instead of the buttons 140A-140B to accomplish the same task. For example, the user may begin to record his/her favorite excerpt by one or more voice commands. As another example, the user may begin to record his/her favorite excerpt by another interactive gesture with the touch screen, such as by a single or double tap of an existing on-screen control mechanism (e.g., the position indicator 130 or the play/pause button 110). In some embodiments, such as an embodiment illustrated in FIG. 4, a user interface 100D includes a virtual “record” button 160 (or another similarly intuitive icon or control) that may be pressed to begin defining the user's favorite excerpt.

Regardless of the specific mechanism used to define the media program excerpt, the media management and playback system can now associate a user-defined media program excerpt with a particular user's account. The user-defined media program excerpt is linked to a specific media program and has a beginning that corresponds to a first point in time of the media program and an end that corresponds to a second point in time of the media program after the first point in time. Instead of having to watch the entire media program (or a substantial portion of it), or having to tediously search for the desired scene, the user may now jump straight into the user-defined excerpt and begin watching one of his/her favorite parts of the media program right away.

Note that the creation of a user-defined excerpt does not need to involve actually creating a digital copy of the portion of the media program corresponding to the user-defined excerpt. Rather, since the media management and playback system knows the start and end times of the user-defined excerpt, the media management and playback system only needs to start playing the media program at that specified start time and end it at that specified end time. In other words, the creation of the user-defined excerpt may involve a very small amount of digital information, namely the name of the media program, the start and end times of the excerpt within the media program, and the name of the excerpt. This small amount of digital information can be easily stored in an electronic database of the media management and playback system and associated with the user's account, and it would not consume too much space at all.

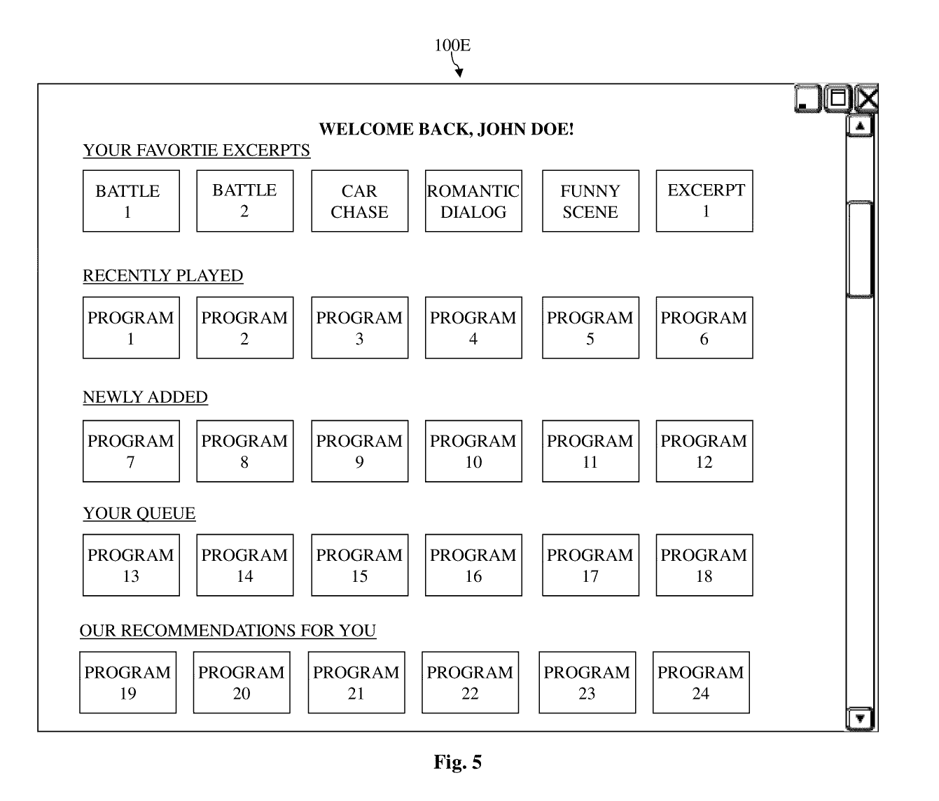

Using the processes discussed above, the user may be able to define a plurality of excerpts for each media program in his/her user account. In some embodiments, the availability of these user-defined media program excerpts may be displayed to the user independently of the specific media program. For example, referring to FIG. 5, a user interface 100E shows an example welcome screen after an example user “John Doe” logs into his/her account with a media program service provider. Among other things, the user interface 100E may display a listing of the user John Doe's favorite excerpts, which may include “Battle 1”, “Battle 2”, “Car Chase”, “Romantic Dialog”, and “Funny Scene”, which are individually defined and named by the user John Doe in this example. The listing of John Doe's favorite excerpts may also include one or more excerpts that John has not specifically named, an example one of which is assigned a default name of “Excerpt 1” herein. Of course, the user John Doe has the option of renaming these excerpts at any time. Also, two or more of these excerpts may originate from the same media program or different media programs.

In the embodiment shown in FIG. 5, these user-defined media program excerpts are displayed as thumbnail images under the heading “your favorite excerpts.” The user may be given a choice to assign a specific image as the thumbnail image displayed for any given excerpt. For example, the user may step through different screenshots of scenes from his/her excerpt and choose a screenshot that is deemed suitable to represent the excerpt as the thumbnail image. In other embodiments, these user-defined media program excerpts may be displayed as linkable-texts or other icons. Meanwhile, the user interface 100E may also list other categories of media programs in the user John Doe's account, such as “Recently Played”, “Newly Added”, “Your Queue”, “Our recommendations for you”, etc.

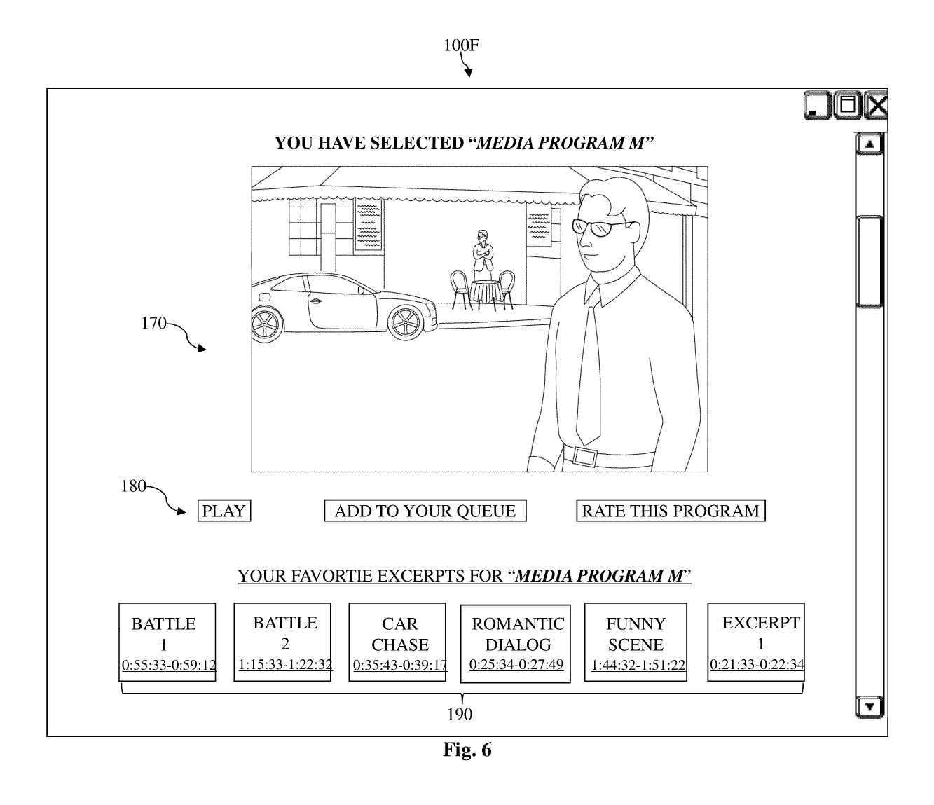

In some embodiments, the availability of one or more user-defined media program excerpts may also be shown in association with a particular media program. An example of this case is shown in FIG. 6, where a user interface 100F displays a screen where the user John Doe has selected a particular media program M for viewing. In addition to showing an image 170 representing the selected media program M and one or more buttons 180 that allow the user to perform various control tasks (e.g., play the media program M, added the media program M to a queue, or rate the media program M, etc), the user interface 100F displays a list of available user-defined excerpts 190 that are associated with this particular media program M. In other words, the user John Doe has previously defined each of these excerpts 190 for this particular media program M. The user John Doe may choose to play any of the excerpts 190 by engaging (e.g., clicking or touching) their respective thumbnail images or icons. Thereafter, the user interface 100F may jump right into the selected excerpt without requiring the user to perform tedious fast forwarding or rewinding tasks through the media program M to locate the scene. When the excerpt is being played, the user John Doe may have the option to perform a “zoomed-in” scrolling function as disclosed in U.S. patent application Ser. No. 13/485,308, filed on May 31, 2012, titled “Method and Apparatus For Enhanced Media Playback Control,” the contents of which are hereby incorporated by reference in their entirety.

In some embodiments, these user-defined excerpts 190 may also each include information indicating the time portions of the media program to which they correspond. For example, “Battle Scene 1” may correspond to a time portion from 55 minutes and 33 seconds to 59 minutes and 12 seconds of the media program M. The availability of such information further simplifies the user's management of his/her media content.

The creation and subsequent availability of these use-defined excerpts greatly enhance users' media viewing experiences. Users may now have instant access to their favorite parts of a media program without having to search for them. This tool is even more beneficial for users who may have forgotten where their favorite parts of the media program are located, which makes searching for these scenes even more difficult. Now, the user can simply go back to a media program that he/she has not watched in years and start watching their favorite scene right away.

In some cases, media programs such as standup comedy shows have a substantially uniform visual presentation throughout. To a viewer like the user, the visual content of the entire show may involve a comedian talking and walking around. Thus, the user may not be able to visually identify what their favorite jokes are located in the standup comedy program just by fast forwarding (or rewinding) through the program. With the embodiments of the present disclosure, if the user particularly likes a few jokes, he can save these jokes by defining an excerpt for each of these jokes, and later go watch the scenes with jokes right away.

In some other cases, young children often times wish to watch a particular scene of a movie (or parts of a song) over and over again. Traditionally, parents would have to perform the tedious task of having to manually search for and/or rewind the media program to find and play these scenes repetitively. Now, parents can define excerpts for each of these scenes, which then allows children to watch them again and again with just a click of a button.

In yet other cases, even if a scene is not necessarily a favorite scene that a user wishes to watch many more times, that user may still watch that scene at least one more time. For example, the user may have just watched a scene in a movie that he does not necessarily like, but nevertheless thought it was interesting, or thought his/her spouse/children/friend may like it instead. Therefore, the user can save that scene as an excerpt and present it to his/her spouse/children/friend at a later time. If no one likes the scene, the user may easily delete it. If someone else does like it, the user may save it. Once again, the user need not go search for that scene within the media program when he/she wants to present it to his/her spouse/children/friend, and this saves time and resources.

In some other cases, one or more scenes from a media program may have educational value. For example, a teacher in school may not have time to show an entire scientific documentary to the students, but the teacher now can define one or more excerpts from the documentary that contain educational points that the teacher wants to emphasize. The teacher may define these excerpts before class time and just show these excerpts during class to save time and be efficient.

In more cases, these user-defined excerpts may not even be that short and may instead take up substantial portions of a media program. For example, a movie may mostly be funny or otherwise interesting, but it may contain some scenes with excessive vulgarity, gratuitous violence, or other age-inappropriate materials. The user such as a parent may wish to show most of the media program to his/her children (or even a friend), but does now want the children to be exposed to the vulgarity/violence/age-inappropriate materials contained in the media program. Now, the user can actually define their favorite scenes to span across most of the media program, but with the undesired scenes left out. Thereafter, the user may present the edited media program (by way of defining excerpts) to their target audience without worrying about harmful exposure to vulgarity or violence, etc.

It is understood that in some embodiments, the media management and playback system may facilitate these operations by specifically allowing the user to create “undesired” or “unwanted” excerpts. In other words, the user may be able to define an excerpt in a media program that he/she does not wish to be included in the media program during a play of the media program at a later time. Though the actual operation performed to define these “undesired” or “unwanted” excerpts may be similar in manner to those regarding their favorite excerpts, the end effect is the opposite—the media program may now be played in its entirety without including these unwanted scenes. In this manner, the user may create a “cleaner” or more filtered viewing experience.

The media service provider may also utilize the user-defined scenes to improve its services by learning more about its users. In some embodiments, the media service provider may catalog all the user-defined favorite excerpts for a plurality of media programs in a database. Using the media management and playback system, the media service provider may analyze these user-defined favorite excerpts to enhance the media consumption experience for it users. For example, by analyzing the database of user-defined excerpts, the media management and playback system may determine that a certain part of a media program is particularly popular among its users. This may be indicated by the fact that many users have created their own user-defined excerpts centered around such portion of the media program. For instance, a great battle sequence from a movie may be popular among many users, who have each defined their individual excerpt for this battle scene. In that scenario, though these user-defined excerpts may not exactly match with one another in terms of timing (e.g., some may be longer or shorter than others by a few seconds or even minutes), the database analysis can still uncover a trend or a pattern by analyzing these excerpts collectively.

Once the media service provider determines a portion of a media program is popular, it may define its own version of an excerpt corresponding to this popular portion of the media program. In some embodiments, the media service provider may define its own excerpt by averaging (e.g., mean or median) of the start times and the end times for all the user-defined excerpts associated with this portion of the media program. Of course, the media service provider may also use human agents to exercise their own artistic or common sense discretions to make edits to the excerpts, so that the final version of such excerpts will have a polished presentation. For example, the result of merely averaging the user-defined excerpts may generate an excerpt that is indeed the most representative of the popular portion of the media program, but it might start and end at an unreasonable time. In some cases, the averaged excerpt may start halfway into a conversation, or end a few seconds too early before a battle is over, etc. The human agents may use common sense to move the start and end times of the media service provider's version of the excerpt so that it will start and end at a reasonable and logical point in time.

In some cases, many movies and some other types of digital media programs have built-in “chapters” that divide the respective media program into a plurality of segments. Thus, the media service provider may also accomplish the editing task discussed above by automatically aligning the start and end times of its own excerpt with the nearest “chapter” of a media program. This may be done in addition to, or as an alternative to using human agents.

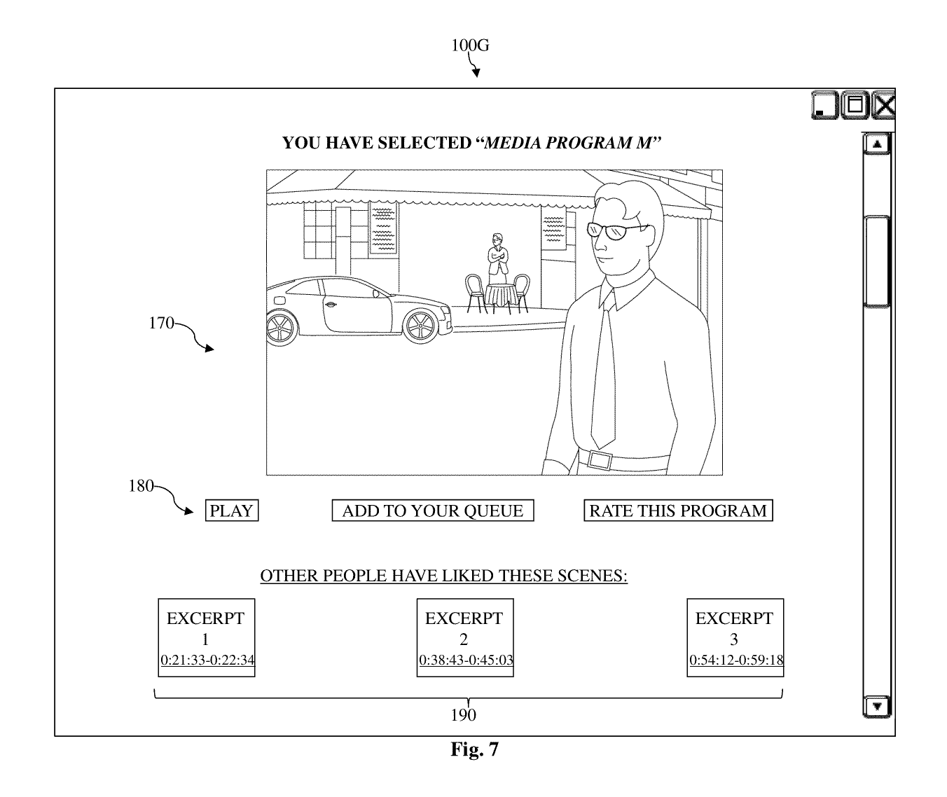

After the media service provider has generated its own excerpts for a media program, it may display the availability of such excerpts to a user. For example, referring to FIG. 7, after a user has selected a media program for viewing, the media management and playback system may advertise the availability of one or more excerpts to the user, for example by displaying the message, “Other people have liked these scenes:”. Even if the user has not viewed this particular media program before, he/she will now know what parts of the media program are particularly popular with other users. If the user so chooses, he/she may jump right into viewing these excerpts.

In some embodiments, the media management and playback system may analyze the user-defined excerpts for each individual user, so as to determine a set of preferences or viewing patterns for that user. In other words, each user's media program taste in terms of what he/she likes or dislikes in media programs in general may be discovered by an analysis of his/her user-defined excerpts. For example, if a user has defined many excerpts based on car chases or other high speed racing scenes, this pattern may be detected by the media management and playback system, which may deem that this user has a “need for speed.” The media management and playback system may then scour its database of media programs and/or excerpts to look for media programs having lots of car chases for the user. The media management and playback system may then recommend these media programs to the user, for example by displaying the titles of these media programs in the “Our recommendations for you” category shown in FIG. 5.

In addition to recommending media programs (which the user might like based on his/her viewing patterns) in their entirety, the media management and playback system may also recommend excerpts that closely match the user's viewing taste. In the example above, the media management and playback system may recommend one or more excerpts involving car chases or other vehicle races to the user. Furthermore, in some embodiments, the user may be able to proactively search for other media programs or excerpts thereof that match his/her viewing taste. For example, the user may base his/her search on an excerpt that he/she has defined and ask the media management and playback system to search its database for other media programs or user-defined excerpts (or even the media program from which the user-defined excerpt is made) that are similar to the excerpt that he has defined.

Based on the discussions above, it can be seen that the various aspects of the present disclosure enables the media management and playback system to become more “intelligent” in learning and adapting to the user's viewing taste. As a result, the media service provider can learn each user's view taste by cataloging and analyzing the user's individually defined media program excerpts. Compared to conventional systems and methods that attempt to predict the user's viewing taste merely by looking at the list of media programs viewed by that user, the collection and analysis of each user's individually defined excerpts according to the present disclosure provides a much better tool in terms of understanding the needs and wants of the user. With such information in hand, the media service provider can serve each user's need more effectively than before, which leads to greater user satisfaction.

But greater user satisfaction is not the only benefit offered by the present disclosure. Since the media service provider can now more accurately gauge each user's viewing taste, it can also predict what media program is likely to be interesting for its collective user base. This is very beneficial for the media service provider's strategic planning For example, media service providers are constantly faced with the decision of how to build and add to its existing media program library. Here is an example scenario: a new movie or a TV show is now available, and it would cost the media service provider an X amount of money to purchase the rights to that movie or TV show for it to be added to the media service provider's library. Should the media service provider do it? To answer that question, the media service provider needs to estimate the value provided by the addition of such movie or TV to the library (e.g., digital streaming library) offered by the media service provider, and weigh that against the cost to acquire such movie or TV show. Traditionally, media service providers often have to make this estimate “in the dark,” as they lacked the tools to accurately gauge and understand the needs and desires of its users.

Now, the media service providers can easily determine which aspects of media programs are most appealing for its users, since users typically create the excerpts that are of most interest to them. With this information on hand, the media service provider can perform analyses on its user base collectively and predict with much greater precision if, and to what extent, a potential candidate media program is likely to appeal to its user base, and to what portions of the user base. In other words, the media service provider can now more accurately determine whether it is worth the cost to acquire a movie, a TV show, or any other media program for its media library. Similarly, if an existing media program is not popular among its users—indicated by information gleaned from doing the analysis on the users' excerpts—the media service provider may decide it is no longer worth the cost to keep such media program in its library. The media service provider may then remove the unpopular media program from its library and reduce operating costs. By doing the above analyses and taking the subsequent logical actions, the media service provider can now run a more efficient operation while still keeping its user base satisfied.

In addition to offering the creation of user-defined excerpts, the present disclosure also offers improved media management capabilities. For example, conventional digital media playback interfaces may display a category of “Newly added” media program after a user logs on to his/her account. As an example, a media service provider providing a media program streaming service or media program downloading service as discussed above may constantly add new media programs to its library of available media programs. This “Newly added” category is meant to let the user know which media programs have just become available in the streaming or downloading library.

However, the drawback associated with conventional digital media playback interfaces is that this category of “Newly added” media programs is not customized for each user. Even though the media service provider may constantly update what has just now become available in its media program library, it is doing so from its own perspective. But the “Newly added” category has limited helpfulness to a user. Often times, the media programs recently added to the service provider's library are interspersed throughout as the user is only viewing media programs in that “Newly added” category. Thus, the user may have difficulty identifying what media programs have been most recently added to the library from his/her perspective.

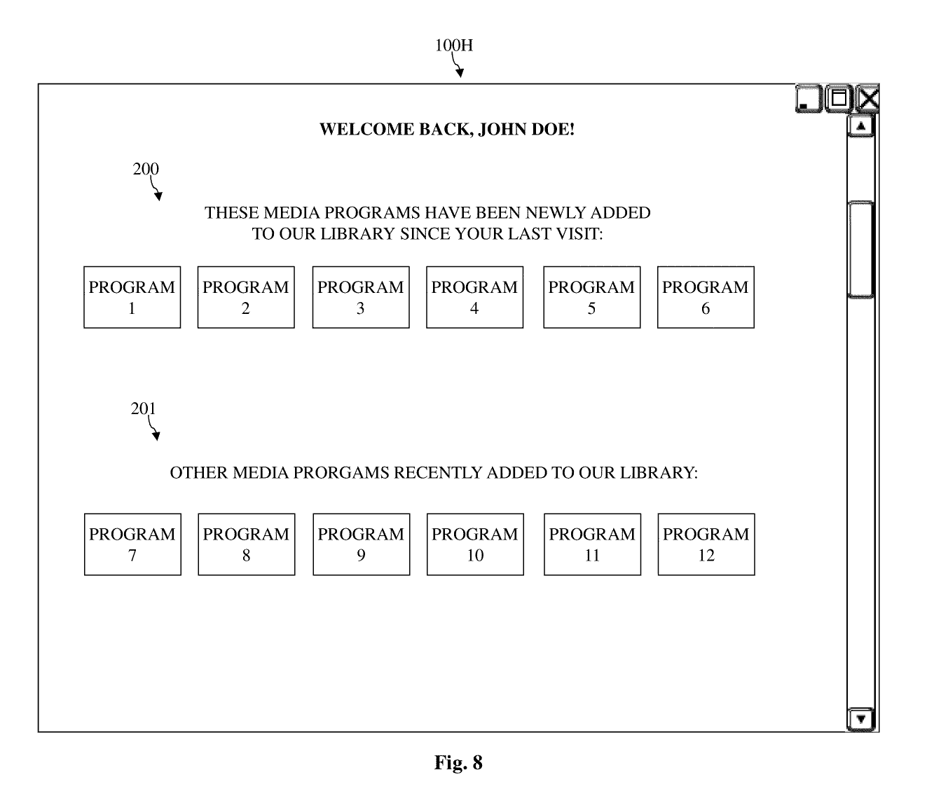

The present disclosure solves this problem by customizing the “Newly added” category of media programs to each individual user based on the user's visits to its account. Referring to FIG. 8, a user interface 100H displays a screen showing a list of media programs newly added to the library of the media service provider. The user interface 100H may be triggered after the user clicks on the “Newly Added” link shown in the user interface 100E of FIG. 5, for example.

The user interface 100H displays media programs newly added to the library in at least two sections 200 and 201. In section 200, the user interface 100H displays a list of media programs added to the library since the user's last visit to his/her account. In section 201, the user interface 100H displays a list of other media programs recently added to the library. In some embodiments, the media programs in these two sections 200-201 are mutually exclusive to one another. For the sake of providing an example and to facilitate the ensuing discussions, the section 200 includes media programs “Program 1”, “Program 2”, “Program 3”, “Program 4”, “Program 5”, and “Program 6”, and the section 201 includes media programs “Program 7”, “Program 8”, “Program 9”, “Program 10”, “Program 11”, and “Program 12”.

The media management and playback system of the media service provider detects the time at which the user logs on to his/her account and records that time, for example in a database entry. The media management and playback system also records the list of media programs available at the time of the user's account access. As an example, suppose the user logs on to his/her account on Jan. 1, 2011. For the sake of simplicity, assume that the media programs available in the service provider's library as of Jan. 1, 2011 include programs 1 through 12 in the above example.

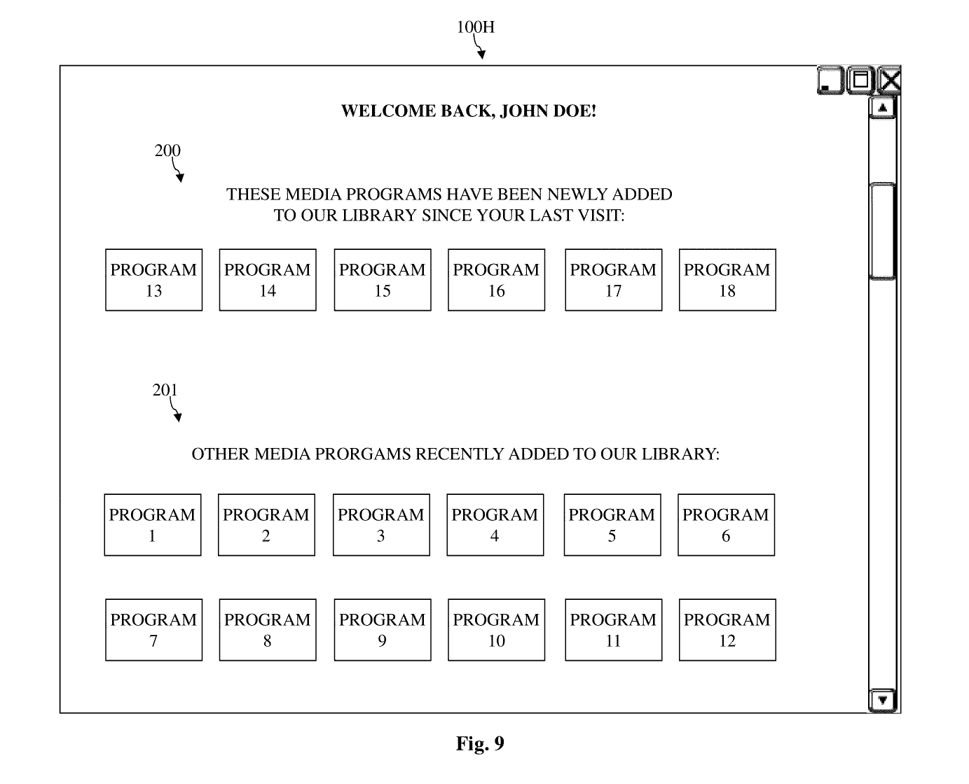

Now referring to FIG. 9, suppose the user's next visit to his/her account is on Jan. 21, 2011. The media management and playback system detects this time of account access and records that time in a database too. The media management and playback system then records the list of media programs available on Jan. 21, 2011, and compares to the previous list (generated on Jan. 1, 2011). Based on the comparison, the media management and playback system identifies a list of media programs which were not available as of Jan. 1, 2011, but is now available as of Jan. 21, 2011. In this simplified example, these newly-available media programs are “Program 13”, “Program 14”, “Program 15”, “Program 16”, “Program 17”, and “Program 18”. The user interface 100H now displays these programs in the section 200, and moves the media programs previously listed in section 200 to section 201. Thus, the section 201 now includes media programs “Program 1”, “Program 2”, “Program 3”, “Program 4”, “Program 5”, and “Program 6”, “Program 7”, “Program 8”, “Program 9”, “Program 10”, “Program 11”, and “Program 12”.

The section 200 is effectively updated based on the user's account access and is therefore truly customized to the user. The user will intuitively see what media programs have been added to the service provider's library since his/her last visit to the account. Having this information available can help the user in managing his/her account. For example, he/she can quickly browse through the media programs listed in section 200 and determine if he is interested in watching any of them, or interested in adding any of them to a queue to be watched later. In comparison, under the old scheme, the user may have to sort through a much larger list of media programs listed in a “newly added” category to find the few ones that are interesting to him, which is a very inefficient process.

It is understood that when doing the comparison between the available media programs at the two different times of user access, the media management and playback system may or may not use the rest of the “non-newly added” media programs as a part of the comparison. In other words, using these other media programs that do not fall under the “newly added” category should not affect the outcome much, if at all. This is because the non-newly added media programs should in theory remain substantially the same at the two different times of user access. Nevertheless, the media management and playback system may decide to use this information (or not) at its own discretion.

In some embodiments, the media management and playback system may automatically (or at the user's request) add a filter to the media programs in sections 200 and 201 so that only true “new releases” are displayed. Stated differently, it is possible that the user is only interested in finding out what latest new releases have been added to the library, for example movies in the last year, and does not want to see that an old movie from the 1970s has been added to the library. In these embodiments, the filter may then limit the display of the media programs in the “newly added” category to media programs released in the past year only.

The process discussed above shown in FIGS. 8-9 is repeated each time the user logs back into his/her account. Each time, he/she is presented with a new list of media programs newly added to the library of the media service provider—assuming that the service provider has indeed added media programs to its library during this time span. If no new media program has been added, the user may be notified as such, and the section 200 may be empty. In any case, the list of media programs appearing in the section 200 is customized to each user. Thus, a user A and a user B may be presented with entirely different looking “newly added” categories of media programs, which are configured to simplify the management tasks for each user.

It is also understood that the time of user account access may be generally defined in terms of dates, as done in the above example, or may be more specific in terms of hours of a day or even minutes. Once again, the media management and playback system may exercise its own discretion in determining how detailed or specific the time of access information needs to be. Also, in some embodiments, the user interface may or may not use two sections such as the sections 200-201 to denote the newly added media programs for the user. For example, the user interface may still display all these newly media programs in one section, but with the media programs that would have belonged to section 200 displayed first before the media programs that would have belonged to section 201. A user may still intuitively know that the media programs shown at the front or the beginning of the “newly added” category are the ones that were added since his/her last visit.

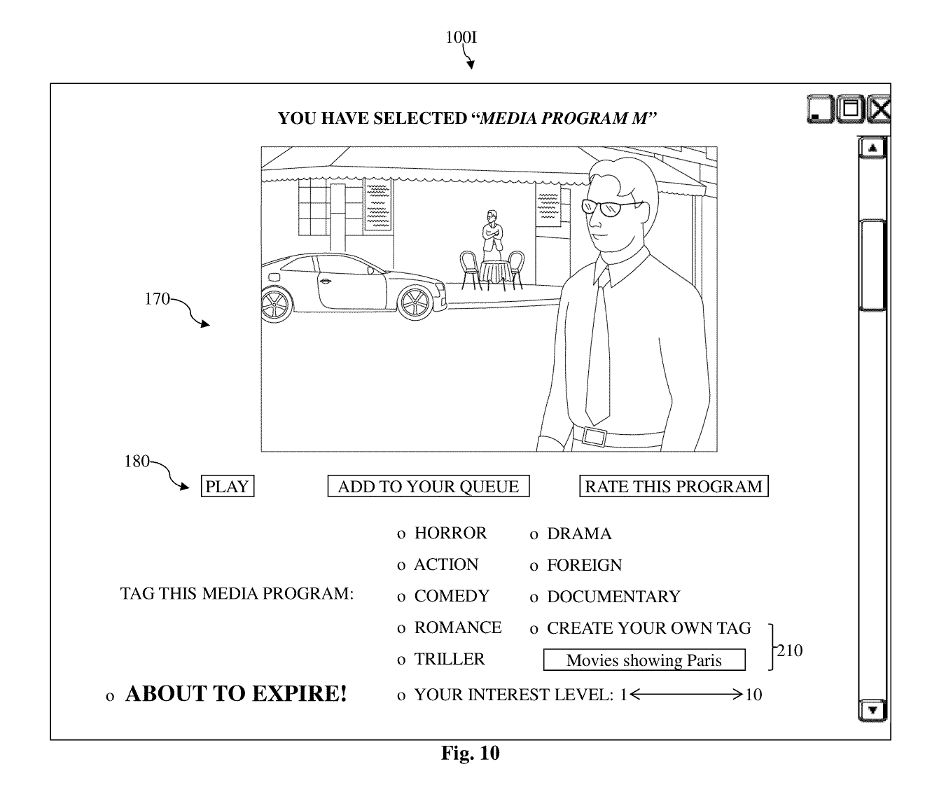

Another aspect of the media management capabilities offered by the present disclosure involves the ability to “tag” the media programs. For example, referring to FIG. 10, when a user selects a media program, the user interface 100I may let the user know he/she can tag the media program. For example, the user interface 100I may display a message “Tag this media program” or something similar. Adjacent to this message, the user interface 100I may offer the user a plurality of predefined tags such as “horror”, “action”, “comedy”, “romance”, “thriller”, “drama”, “foreign”, “documentary”, etc. The user may assign multiple tags to the media program if he wishes to do so. In addition, the user interface 100I lets the user create his/her own user-defined tag 210 for the media program. The user may then tag the media program with any tag he desires, for example “movies showing Paris” in the example illustrated in FIG. 10. If the user does not choose to input a tag manually, the user interface may automatically assign one or more predefined tags to the media program.

In some embodiments, a predefined “tag” may be prompting the user's interest level in a selected media program, for example in a scale from 1 to 10. If the user is really interested in the media program, he may tag it with a high score (close to 10). If the user has only a moderate level of interest, he may tag it with a lower score (for example 4 or 5). This “interest level” tag may also be used in a filtering process discussed below.

In some embodiments, a predefined “about to expire” tag may be displayed for the media program. In these cases, the selected media program is about to be removed from the library of the media service provider, for example in a few days or a few weeks. For media programs that fall under this description, they may be automatically assigned the “about to expire” tag, so that the user will know that these media programs will not be available for viewing much longer. The user may then take appropriate action, such as viewing the media program immediately if he wishes to do so.

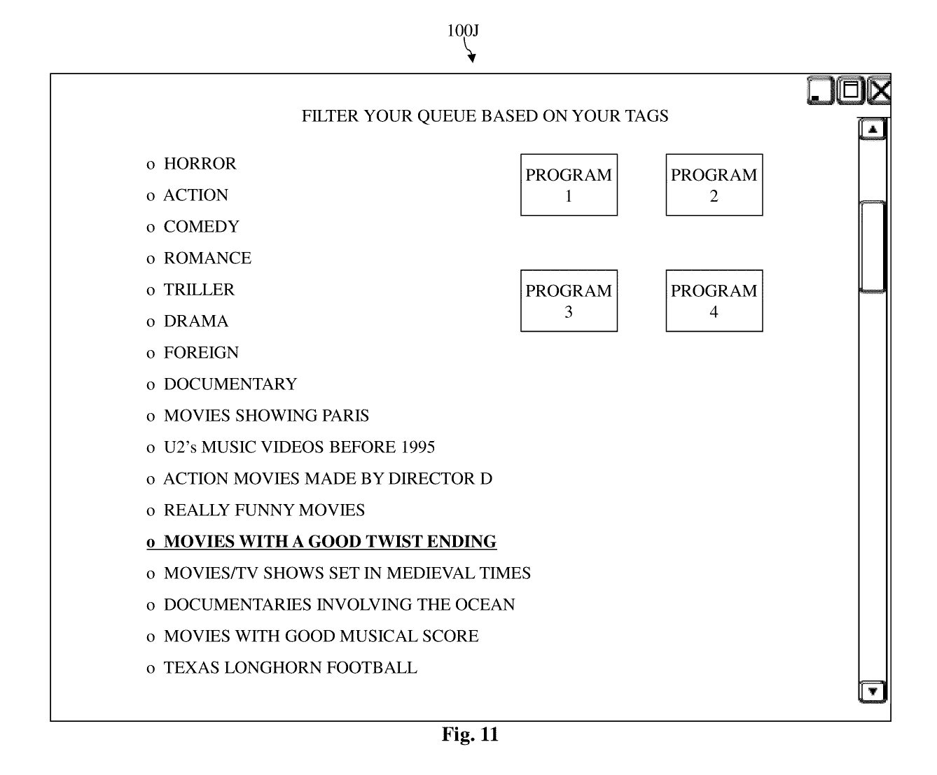

The user may then manage his/her queue of media programs based on the tags. For example, referring to FIG. 11, the user interface 100J may display a plurality of tags, some of which are user defined. For example, these user-defined tags include: “movies showing Paris”, “U2's music videos before 1995”, “action movies made by director D”, “really funny movies”, “movies with a good twist ending”, “movies/TV shows set in medieval times”, “documentaries involving the ocean”, “movies with good musical score”, “Texas Longhorn Football”, etc. As discussed above, the user may create as many tags as he likes, specifying whichever criteria he wishes.

Once the user chooses a tag, his/her queue is filtered to bring up only the media programs having the matching tags. In the example shown in FIG. 11, the user has selected the tag “movies with a good twist ending” as the tag, and the queue is filtered with this tag to bring up the media programs 1-4, which all have been tagged by the user as having a good twist ending previously. If the user adds another tag to further limit his/her selection, (e.g., “movies with good musical score”), the queue is further filtered to narrow the list down some more (not illustrated herein for the sake of simplicity). The remaining selection should include list of media programs matching both tags.

Thus, the present disclosure offers the ability to let the user tag media programs, particularly with the user-defined tags, and subsequently filter his/her queue with one or more of these tags. By doing so, the user can quickly locate the target media program(s) he/she wishes to view. This feature is particularly helpful if the user has maintained an account with a particular service provider over a long period of time, during which his/her queue continues to expand to include more and more media programs. As this process takes place, it is not uncommon for even an average to accumulate hundreds (or more) of media programs in his/her queue. At that point, managing the queue or browsing through the queue to locate a media program of interest may be challenging. Here, with the ability to tag the media programs and quickly filter the queue with the tag, the user can once again manage his/her queue with ease.

It is understood that the tagging aspect of the present disclosure may be implemented in combination with the creation of user-defined excerpts discussed above. For example, the user may be allowed to tag not only an entire media program, but also to tag the user-defined excerpts as well. The media management and playback system of the media service provider may also catalog these tags and try to learn more about the user based on the tags that he/she has generated. After learning the user's viewing taste and/or tendencies with the help of the tags associated with the user, the media service provider may then be able to provide more customized programming or recommendation to the user, in a manner similar to that described above with reference to the user-defined excerpts. For example, a user may search an entire library of available media programs based on tags similar to tag defined by the user, such as “really funny movies.” In response to this query, other movies that have been tagged by different users with similar tags may be displayed to the user. And similar to the case involving user-defined excerpts, the tagging information for the user base collectively may be gleaned and analyzed by the media service provider to more accurately gauge what media programs are likely appealing to the users and therefore should be added to the media library of the media service provider. In this manner, the tagging feature of the present disclosure also enables the media service provider to make better business decisions.

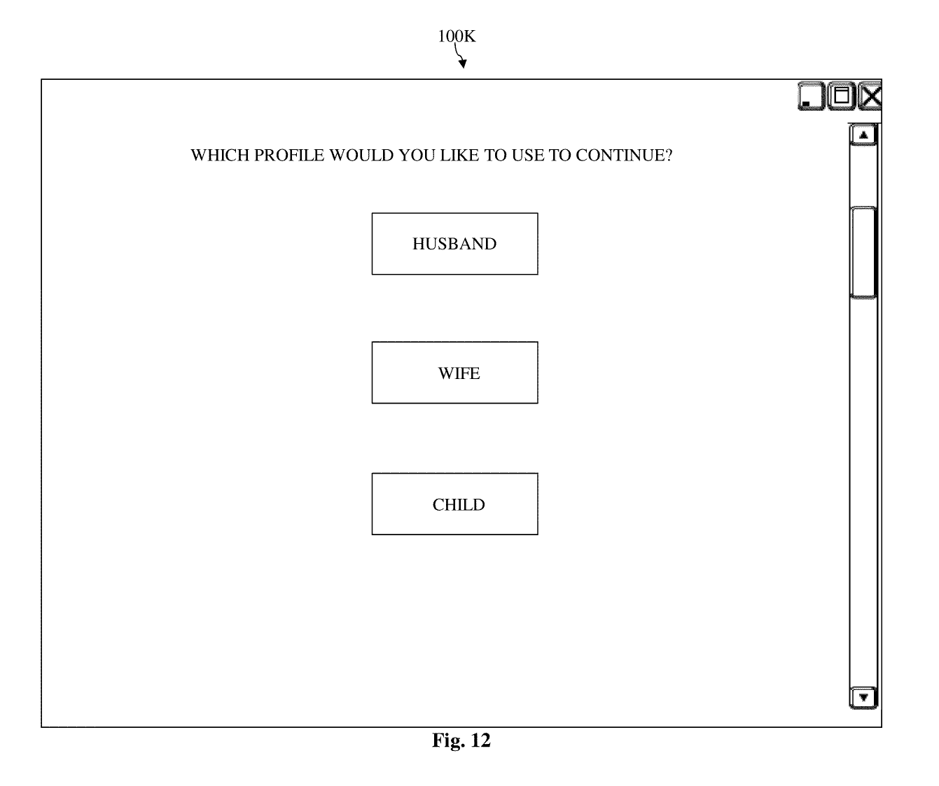

The present disclosure also enables the creation of different sub-accounts (or profiles) under each user's account. For example, a user may create a first profile for himself, a second profile for his/her spouse, and a third profile for his/her child. An example of this is illustrated in the user interface 100K shown in FIG. 12. Once the user logs in, he can choose to perform various media program management and/or viewing tasks under any of these profiles. Among other advantages, one benefit offered by the multiple profiles is that each profile can have an associated media programs queue. Each queue is different and is customized based on the preferences set forth by the person associated with the profile. This solves the problem of “contaminated queues” associated with conventional systems. For example, a husband and a wife may share a single account with a media service provider and share a joint queue. The husband and wife both add media programs they are interested in to the joint queue. However, the husband may not be interested in the “chick-flicks” that the wife is constantly adding to the queue, nor is the wife happy about the sports-oriented media programs that the husband is always adding to the queue. From each of their perspectives, the queue is “contaminated” with unwanted media programs.

According to the present disclosure, however, multiple members of a family may be able to keep their interested media programs segregated from one another. In the above example, the husband no longer has to see the wife's chick-flicks in the queue associated with his/her profile, and the wife need not see the husband's sports-related media programs either. The end result is a more satisfying user experience for everyone involved.

It is understood that the user under different profiles may also tag the media programs differently in the separate queues. For example, the husband (using his/her profile) may tag a movie with an “awesome ending!” tag, while the wife (using her profile) may tag the same movie with a tag “weird ending.” In some embodiments, the user interface may allow the queues associated with two or more profiles to be merged upon user request. However, the user still can automatically separate the merged queues at any time.

In some embodiments, the user may also share or export a queue associated with each profile. For example, the wife may share the media program queue associated with her profile with her friends on a social media website such as FACEBOOK®, GOOGLE PLUS®, or PINTEREST®, etc. She may also email the queue to a target recipient. In these cases, the person who received this queue (whether from the social media website sharing or through email) may then incorporate that queue (or a portion thereof) into his/her account with the same media service provider, or even into an account with a different media service provider. In a similar manner, a user may (under a given profile of the account) share or send his/her user-defined excerpt (or a link to the excerpt) to another person. This allows the recipient to watch the user-defined excerpt without the user having to instruct the recipient where and how to find the scenes he wishes the recipient to watch.

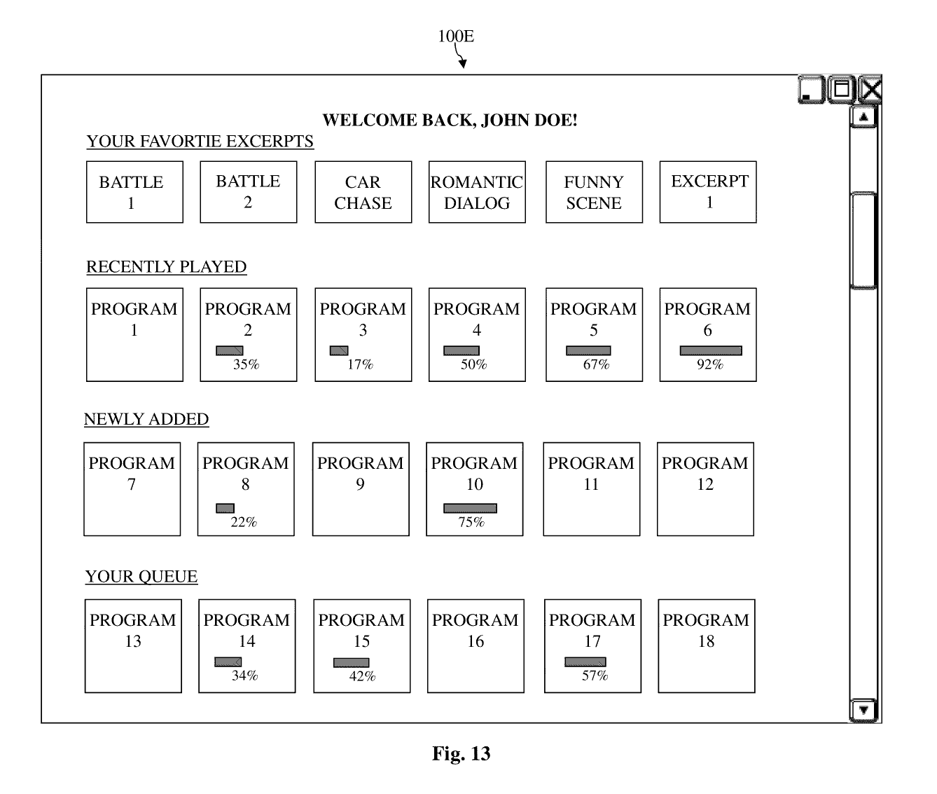

In some embodiments of the present disclosure, the amount of viewing progress made for each media program is also visually communicated to the user. For example, this may be implemented in a user interface 100L shown in FIG. 13, which in this example shows what the user sees when he/she logs on to his/her account. A progress bar may be shown adjacent to, or embedded within, each of the icons representing media programs. The length of the progress bar may represent the amount of viewing completed for the media program. For example, no progress bar indicates the media program has not been watched (or has already been 100% completed and will now resume from the beginning), a shorter progress bar indicates not much of the media program has been watched, and a longer progress bar indicates a significant amount of viewing progress has been made. In some embodiments, a percentage number will also be shown accompanying the progress bar, where the percentage number corresponds to the percentage of the media program that has been viewed. Having the viewing progress information visually available to the user also simplifies media program management decisions for the user.

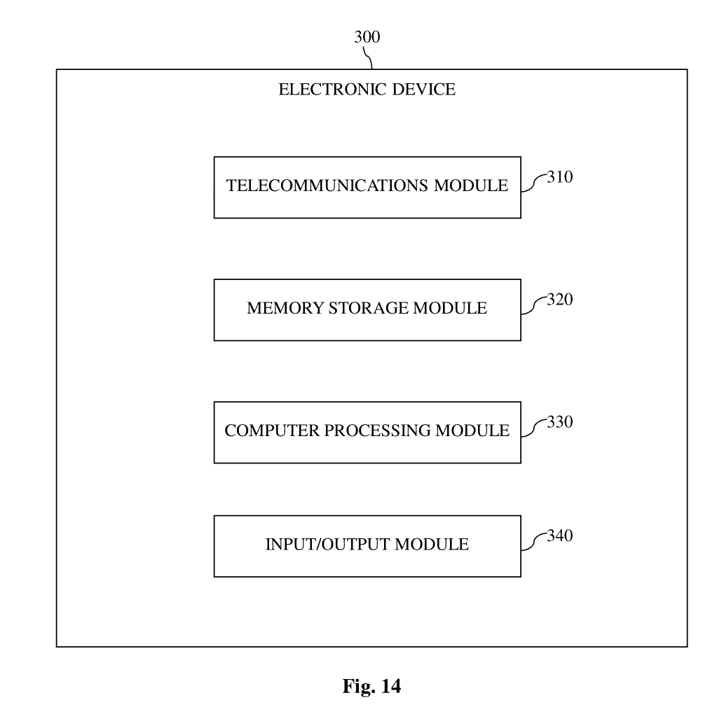

FIG. 14 is a simplified block diagram of an embodiment of an electronic device 300 according to the various aspects of the present disclosure. The electronic device 300 includes a telecommunications module 310. The telecommunications module 310 contains various electronic circuitry components configured to conduct telecommunications with one or more external devices. The electronic circuitry components allow the telecommunications module 310 to conduct telecommunications in one or more of the wired or wireless telecommunications protocols, including communications protocols such as IEEE 802.11 (WiFi), IEEE 802.15 (Bluetooth), GSM, CDMA, LTE, WIMAX, DLNA, HDMI, etc. In some embodiments, the telecommunications module 310 includes antennas, filters, low-noise amplifiers, digital-to-analog (DAC) converters, analog-to-digital (ADC) converters, and transceivers. The transceivers may further include circuitry components such as mixers, amplifiers, oscillators, phase-locked loops (PLLs), and/or filters. Some of these electronic circuitry components may be integrated into a single discrete device or an integrated circuit (IC) chip.

The electronic device 300 may include a computer memory storage module 320. The memory storage module 320 may contain various forms of digital memory, such as hard disks, FLASH, SRAM, DRAM, ROM, EPROM, memory chips or cartridges, etc. Computer programming code may be permanently or temporarily stored in the memory storage module 320, for example.

The electronic device 300 may also include a computer processing module 330. The computer processing module 330 may contain one or more central processing units (CPUs), graphics processing units (GPUs), or digital signal processors (DSPs), which may each be implemented using various digital circuit blocks (including logic gates such as AND, OR, NAND, NOR, XOR gates, etc) along with certain software code. The computer processing module 330 may be used to execute the computer programming code stored in the memory storage module 320.

The electronic device 300 may also include an input/output module 340. In some embodiments, the input/output module 340 may include one or more touch-sensitive screens, physical and/or virtual buttons (such as power and volume buttons) on or off the touch-sensitive screen, physical and/or virtual keyboards, mouse, track balls, speakers, microphones, light-sensors, light-emitting diodes (LEDs), communications ports (such as USB or HDMI ports), joy-sticks, image-capture devices (for example cameras), etc. In some embodiments, the touch-sensitive screen may be used to display the media program discussed above. User management and playback of the media program according to the various embodiments discussed above may also be accomplished at least in part using the touch-sensitive screen and/or other components of the input/output module 340. In alternative embodiments, a non-touch screen display may be implemented as a part of the input/output module 340.

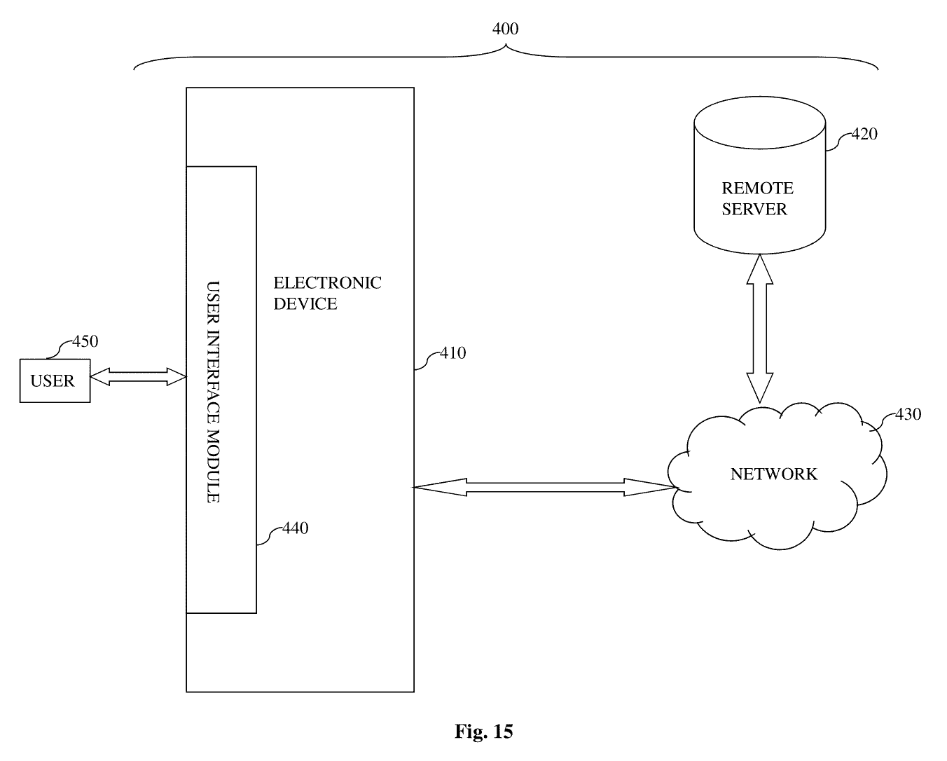

FIG. 15 is a simplified diagrammatic view of a system 400 that may be used to perform certain aspects of the media program management and playback of the present disclosure discussed above. For example, at least some parts of the system 400 may be implemented as the media management and playback system of the media service provider discussed above. In some embodiments, the system 400 may include an electronic device 410. The electronic device 410 may be implemented as an embodiment of the electronic device 300 of FIG. 13. In some embodiments, the electronic device 410 includes a desktop computer, a laptop computer, a tablet computer, a mobile telephone, or a television set.

The system 400 also includes a remote server 420. The remote server 420 may be run/hosted/operated by a media service provider such as NETFLIX®, AMAZON®, APPLE®, HULU®, COMCAST, VUDU, REDBOX®, or another suitable media service provider that offer various types of video streaming or downloading services for their subscribers. The remote server 420 may be implemented in a “cloud” computing environment and may include one or more databases that store a plurality of media programs such as movies, TV shows, documentaries, music videos, podcasts, soundtracks, educational programs, sporting events, artistic performances, or any other type of suitable audio/video digital file that can be played on the electronic device 410.

The electronic device 410 and the remote server 420 may be communicatively coupled together through a network 430. The network 430 may include cellular towers, routers, switches, hubs, repeaters, storage units, cabling (such as fiber-optic cabling or telephone cabling), and other suitable devices. The network 430 may be implemented using any of the suitable wired or wireless networking protocols. The electronic device 410 and the remote server 420 may also be able to communicate with other devices on the network 430 and either carry out instructions received from the network, or send instructions through the network to these external devices to be carried out.

To facilitate user interaction with its offered services, the media servicer provider (that hosts or operates the remote server 420) may provide a user interface module 440. The user interface module 440 may include software programming code and may be installed on the electronic device 410 (for example in a memory storage module). In some embodiments, the user interface module 440 may include a downloadable “app”, for example an app that is downloadable through a suitable service such as APPLE's® ITUNES®, THE APP STORE® from APPLE®, ANDROID's® PLAY STORE®, AMAZON's® INSTANT VIDEO®, MICROSOFT's® WINDOWS STORE®, RESEARCH IN MOTION's® BLACKBERRY APP WORLD®, etc. In the embodiment shown, the user interface module 440 includes an instance of the “app” that has been downloaded and installed on the electronic device 440.

A user 450 may interact with the system 400 by sending instructions to the electronic device 410 through the user interface module 440. For example, the user 450 may be a subscriber of the services offered by the service provider running/hosting/operating the remote server 420. The user 450 may attempt to log in to the remote server 420 by launching the “app” of the user interface 440. The user's login credentials are electrically sent to the remote server 420 through the network 430.

After verifying the user login credentials, the remote server 420 may instruct the user interface module 440 to display a suitable home screen, through which the user 450 may select a desired media program to watch. The media program selection request from the user 450 is once again sent to the remote server 420 through the network 430. In response to the user selection request, the remote server 420 may begin sending electric packets (of the digital file corresponding to the requested media program) to the electronic device 410 through the network 430. As such, the user 450 may be able to stream his/her target media program of choice. Alternatively, the user 450 may download the selected media program in its entirety and may then play the downloaded media program at any time he wishes. User management and playback of the media program according to the embodiments discussed above with reference to FIGS. 1-13 may be implemented through, or as a part of, the user interface module 440.

It is understood that the embodiment of the system 400 shown in FIG. 14 is merely a simplified example of simplifying user management and playback of media programs and is therefore not intended to be limiting. Other embodiments may be implemented that utilize different types of streaming architectures, or even with no streaming at all. As discussed above, the various aspects of the user management and playback of media programs may still apply to media programs that have already been downloaded to an electronic device such as the electronic device 410 of FIG. 14.

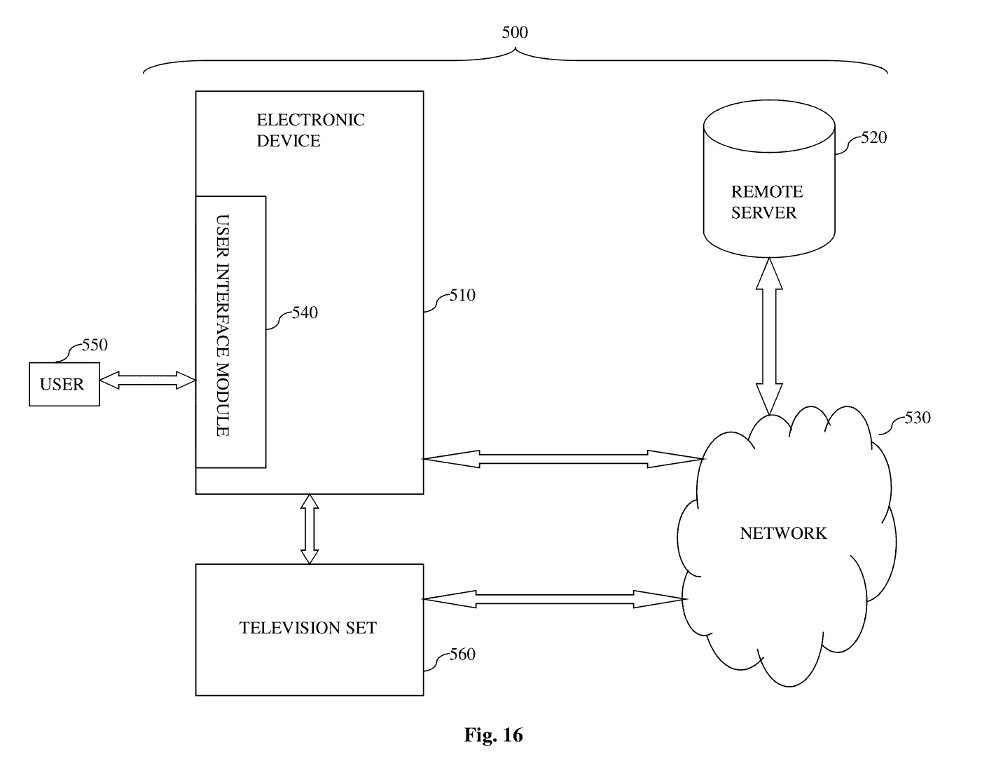

FIG. 16 is a simplified diagrammatic view of another system 500 that may be used to perform certain aspects of the media program navigation of the present disclosure discussed above. The system 500 is similar to the system 400 of FIG. 15 in certain aspects. For example, the system includes a remote server 520 that is similar to the remote server 420, as well as a network 530 that is similar to the network 430. However, in the system 500, the media program is streamed to (or downloaded first and later played on) a television set 560, rather than to the electronic device 510.

The television set 560 may include components (for example, transceivers) that allow the television set 560 to be communicatively coupled to the electronic device and the network 530. The electronic device 510 may be configured to control the operation of the television set 560. In that sense, the electronic device 510 may be viewed as an enhanced TV remote. The electronic device 510 may still be implemented to include a tablet computer or a mobile telephone, or may just include a simple control panel or control pad having a touch screen. An instance of the user interface module 540 may be installed on either the electronic device 540 or on the television set 560. Once again, according to various aspects of the present disclosure discussed above with reference to FIGS. 1-13, a user 550 may interact with the electronic device 510 to perform various management and playback tasks for media programs that are played on the television set 560.

In certain other alternative embodiments, the media program may be downloaded to a storage device (for example on a desktop or a laptop computer) under the user's possession. The storage device may be configured to electronically communicate with the television set 560 and the electronic device. Thus, the media program may be streamed to the television set 560 through a local network (which may be implemented as a part of the network 530) from such storage device. Once again, the various aspects of media management and playback discussed above may still apply to such set-up.

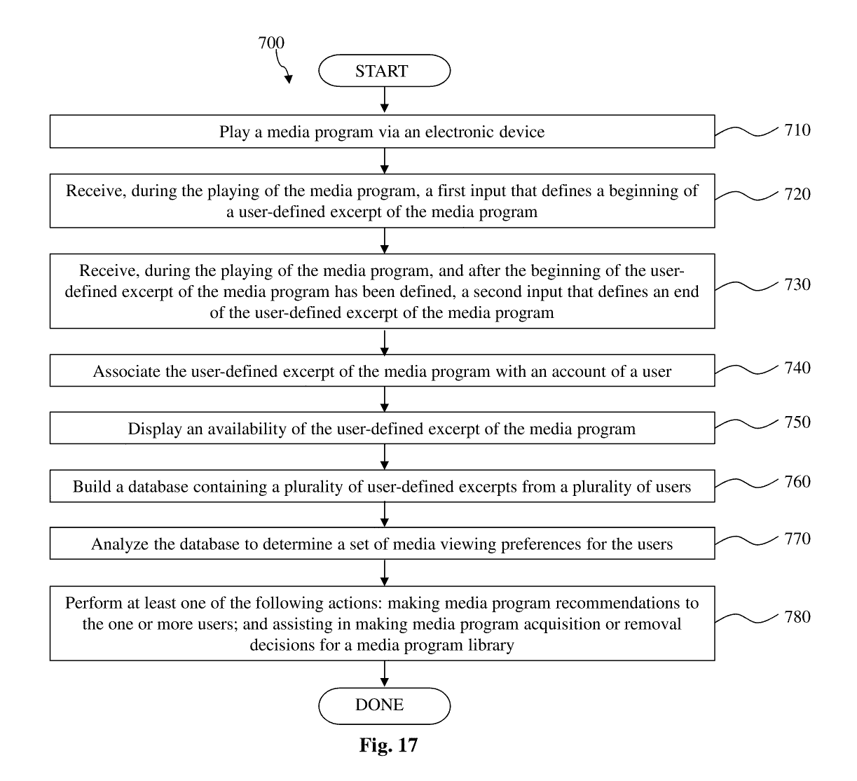

FIG. 17 is a flowchart of an example method 700 for creating a user-defined excerpt according to the various aspects of the present disclosure. The method 700 includes a step 710, in which a media program is played via an electronic device. In some embodiments, the electronic device includes a portable electronic device such as a desktop computer, a laptop computer, a tablet computer, a smartphone, or a TV set. In some embodiments, the portable electronic device may include a touch screen on which the media program is played. In some embodiments, the step 710 includes streaming the media program to the electronic device from an online database via a wireless or wired telecommunications protocol. In other embodiments, the step 720 includes playing the media program that is stored locally on the electronic device.

The method 700 includes a step 720, in which a first input is received during the playing of the media program. The first input defines a beginning of a user-defined excerpt of the media program. In some embodiments, the first input includes a gesture-based interaction with a touch screen display of the electronic device from the user. In some embodiments, the beginning of the user-defined excerpt is associated with an X point in time of the media program.

The method 700 includes a step 730, in which a second input is received during the playing of the media program and after the beginning of the user-defined excerpt of the media program has been defined. The second input defines an end of the user-defined excerpt of the media program. In some embodiments, the second input includes a gesture-based interaction with a touch screen display of the electronic device from the user. In some embodiments, the user may be prompted to name the user-defined excerpt. In some embodiments, the end of the user-defined excerpt is associated with a Y point in time of the media program.

The method 700 includes a step 740, in which the user-defined excerpt of the media program is associated with an account of a user.

The method 700 includes a step 750, in which an availability of the user-defined excerpt of the media program is displayed. In some embodiments, the step 750 includes displaying the user-defined excerpt in association with the media program. In other embodiments, the step 750 includes displaying the user-defined excerpt along with a plurality of other user-defined excerpts associated with other media programs. In some embodiments, the name of the excerpt is displayed in step 750. In some embodiments, a thumbnail image representing the excerpt is displayed in step 750.

The method 700 includes a step 760, in which a database is built. The database contains a plurality of user-defined excerpts from a plurality of users.

The method 700 includes a step 770, the database is analyzed to determine a set of media viewing preferences for one or more of the users. As an example, the set of media viewing preferences may include the user's likes and dislikes (e.g., his/her taste) in terms of viewing media programs.

The method 700 includes a step 780, in which at least one of the following actions is formed based on the analyzing done in step 770: making media program recommendations to the one or more users; and assisting in making media program acquisition or removal decisions for a media program library.

It is understood that the method 700 may include additional steps performed before, during, or after the steps 710-780 discussed above. For example, the method 700 may include a step to play the user-defined excerpt in response to user request. The playing of the user-defined excerpt may be performed by playing the media program starting from the X point in time and ending at the Y point in time. As another example, the method 700 may include a step to facilitate a sharing of the user-defined excerpt. For example, such step may include facilitating the sharing of the user-defined excerpt over a social media network. As another example, the step may include facilitating a transmission, via an electronic message, of the user-defined excerpt or a link thereto to a target recipient. Though additional steps may be performed for the method 700, these other additional steps are not described in detail herein for reasons of simplicity.

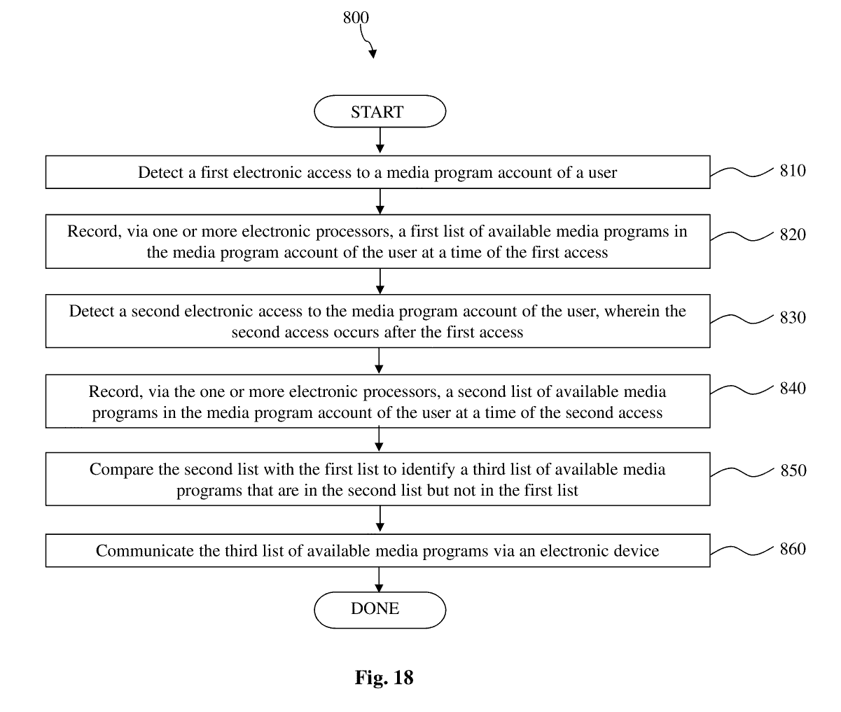

FIG. 18 is a flowchart of a method 800 of displaying media content. The method 800 includes a step 810, in which a first electronic access to a media program account of a user is detected.

The method 800 includes a step 820, in which a first list of available media programs in the media program account of the user at a time of the first access is recorded via one or more electronic processors.

The method 800 includes a step 830, in which a second electronic access to the media program account of the user is detected. The second access occurs after the first access.

The method 800 includes a step 840, in which a second list of available media programs in the media program account of the user at a time of the second access is recorded via the one or more electronic processors. In some embodiments, the first list of available media programs and the second list of available media programs each include media programs belonging to a newly-added category of the media program account.

The method 800 includes a step 850, in which the second list is compared with the first list to identify a third list of available media programs that are in the second list but not in the first list.

The method 800 includes a step 860, in which the third list of available media programs is communicated via an electronic device. In some embodiments, the step 860 includes: in response to a request from the user to view a selection of media programs in the newly-added category, displaying the third list of available media programs separately from displaying other media programs in the newly-added category. In some embodiments, the step 860 includes: in response to a request from the user to view a selection of media programs in the newly-added category, displaying the third list of available media programs before displaying other media programs in the newly-added category. In some embodiments, the media programs in the third list include media programs added to the media program account since the time of the first access.

In some embodiments, the steps 810-860 are each performed at least in part by one or more computer servers of a media service provider.

In some embodiments, the media programs in the first list, second list, or third list include media programs that are electronically stream-able from an online database via a wireless or wired telecommunications protocol. In some other embodiments, the media programs in the first list, second list, or third list include media programs that are electronically stored locally on the electronic device.

In some embodiments, the electronic device includes at least one of: a laptop, a television set, a tablet computer, and a mobile telephone each having a screen component for displaying the third list of media programs.

It is understood that the method 800 may include additional steps performed before, during, or after the steps 810-860 discussed above. However, these other additional steps are not described in detail herein for reasons of simplicity.

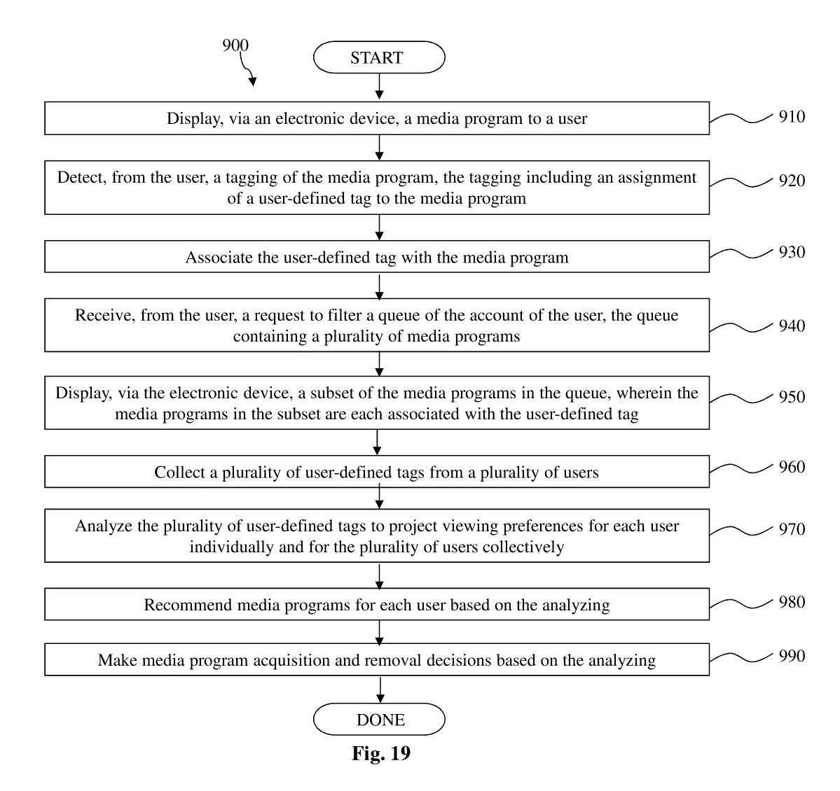

FIG. 19 is a flowchart of a method 900 of managing media programs in an account of a user. The method 900 includes a step 910, in which a media program is displayed to a user via an electronic device. In some embodiments, the electronic device is a portable electronic device having a touch screen, and wherein the displaying the media program is performed using the touch screen. In some embodiments, the account of the user contains a plurality of different user profiles.

The method 900 includes a step 920, in which a tagging of the media program is detected from the user. The tagging includes an assignment of a user-defined tag to the media program. In some embodiments, the user-defined tag includes an interest level of the user with respect to the media program. In some embodiments, the tagging of the media program originates from one of the user profiles.

The method 900 includes a step 930, in which the user-defined tag is associated with the media program. In some embodiments, the associating is performed so that the user-defined tag is associated only with the profile from which the tagging originated.

The method 900 includes a step 940, in which a request to filter a queue of the account of the user is received. The queue contains a plurality of media programs.

The method 900 includes a step 950, in which a subset of the media programs in the queue is displayed via the electronic device. The media programs in the subset are each associated with the user-defined tag.

The method 900 includes a step 960, in which a plurality of user-defined tags are collected from a plurality of users.

The method 900 includes a step 970, in which the plurality of user-defined tags are analyzed to project viewing preferences for each user individually and for the plurality of users collectively.

The method 900 includes a step 980, in which media programs for each user are recommended based on the analyzing.

The method 900 includes a step 990, in which media program acquisition and removal decisions are made based on the analyzing.

In some embodiments, at least some of the steps 910-990 may be performed at least in part by one or more computer servers of a media service provider.

In some embodiments, the media programs are electronically stream-able from an online database via a wireless or wired telecommunications protocol. In other embodiments, the media programs are electronically stored locally on the electronic device.

It is understood that the method 900 may include additional steps performed before, during, or after the steps 910-990 discussed above. For example, the method 900 may further include maintaining a separate queue for each of the user profiles. However, other additional steps are not described in detail herein for reasons of simplicity.

According to one aspect of the present disclosure, an electronic device is disclosed. The electronic device includes: an electronic user interface component configured to play a media program; a memory storage component configured to store computer programming code; and a computer processor component configured to execute the computer programming code to perform the following: receiving, during a playing of the media program, a first input that defines a beginning of a user-defined excerpt of the media program; receiving, during the playing of the media program, and after the beginning of the user-defined excerpt of the media program has been defined, a second input that defines an end of the user-defined excerpt of the media program; associating the user-defined excerpt of the media program with an account of a user; and thereafter displaying an availability of the user-defined excerpt of the media program.

In some embodiments, the electronic device includes a portable electronic device with a touch screen display; and the first input and the second input each include a gesture-based interaction with the touch screen display from the user.

In some embodiments, the displaying the availability of the user-defined excerpt comprises at least one of: displaying the user-defined excerpt in association with the media program; and displaying the user-defined excerpt along with a plurality of other user-defined excerpts associated with other media programs.

In some embodiments, the computer processor component is configured to execute the computer programming code to further perform: prompting the user to name the user-defined excerpt after the beginning and the end of the user-defined excerpt have been defined; receiving a name for the user-defined excerpt in response to user input; and wherein the displaying the availability of the user-defined excerpt comprises displaying at least one of: the name of the user-defined excerpt, and a thumbnail image of a scene from the user-defined excerpt.

In some embodiments, the computer processor component is configured to execute the computer programming code to further perform: associating the beginning of the user-defined excerpt with an X point in time of the media program; and associating the end of the user-defined excerpt with a Y point in time of the media program, wherein Y occurs later in time than X; playing, in response to user request, the user-defined excerpt by playing the media program starting from the X point in time and ending at the Y point in time.

In some embodiments, the media program is stored locally on one of: the electronic device, and a remote server of a service provider; and the electronic device includes an electronic communications component configured to communicate with the remote server to stream the media program to the electronic device via a telecommunications protocol.

According to one aspect of the present disclosure, a method of managing media playback is disclosed. The method includes: playing a media program via an electronic device; receiving, during the playing of the media program, a first input that defines a beginning of a user-defined excerpt of the media program; receiving, during the playing of the media program, and after the beginning of the user-defined excerpt of the media program has been defined, a second input that defines an end of the user-defined excerpt of the media program; associating the user-defined excerpt of the media program with an account of a user; and thereafter displaying an availability of the user-defined excerpt of the media program.

In some embodiments, the electronic device includes a portable electronic device with a touch screen display; and the first input and the second input each include a gesture-based interaction with the touch screen display from the user.

In some embodiments, the displaying the availability of the user-defined excerpt comprises at least one of: displaying the user-defined excerpt in association with the media program; and displaying the user-defined excerpt along with a plurality of other user-defined excerpts associated with other media programs.

In some embodiments, the method further includes: prompting the user to name the user-defined excerpt after the beginning and the end of the user-defined excerpt have been defined; and receiving a name for the user-defined excerpt in response to user input; wherein the displaying the availability of the user-defined excerpt comprises displaying at least one of: the name of the user-defined excerpt, and a thumbnail image of a scene from the user-defined excerpt.

In some embodiments, the method further includes: playing the user-defined excerpt in response to user request.

In some embodiments, the method further includes: associating the beginning of the user-defined excerpt with an X point in time of the media program; and associating the end of the user-defined excerpt with a Y point in time of the media program, wherein Y occurs later in time than X; wherein the playing the user-defined excerpt comprises: playing the media program starting from the X point in time and ending at the Y point in time.

In some embodiments, the playing the media program includes one of: streaming the media program to the electronic device from an online database via a wireless or wired telecommunications protocol; and playing the media program from a local computer storage on the electronic device.

In some embodiments, the method further includes: building a database containing a plurality of user-defined excerpts from a plurality of users; and analyzing the database to determine a set of media viewing preferences for one or more of the users.

In some embodiments, the method further includes: performing at least one of the following actions based on the analyzing: making media program recommendations to the one or more users; and assisting in making media program acquisition or removal decisions for a media program library.

In some embodiments, the method further includes: facilitating a sharing of the user-defined excerpt. In some embodiments, the facilitating the sharing includes facilitating the sharing of the user-defined excerpt over a social media network. In some embodiments, the facilitating the sharing includes facilitating a transmission, via an electronic message, of the user-defined excerpt or a link thereto to a target recipient.

According to one aspect of the present disclosure, a system for managing and playing digital media is disclosed. The system includes: a computer storage configured to electronically store a plurality of media programs each in a digital format; and a user interface module installed on an electronic device located remotely from the computer storage, wherein the electronic device is configured to communicate with the computer storage via a wireless or wired telecommunications protocol, and wherein the user interface module contains computer programming instructions, that when executed, perform the following tasks: receiving, during a playing of one of the media programs stored on the computer storage, a first input that defines a beginning of a user-defined excerpt of the media program; receiving, during the playing of the media program, and after the beginning of the user-defined excerpt of the media program has been defined, a second input that defines an end of the user-defined excerpt of the media program; associating the user-defined excerpt of the media program with an account of a user; and thereafter displaying an availability of the user-defined excerpt of the media program.

In some embodiments, the computer storage includes a plurality of computer servers of a media service provider; the electronic device includes a portable electronic device with a touch screen display; and the first input and the second input each include a gesture-based interaction with the touch screen display from the user.

In some embodiments, the displaying the availability of the user-defined excerpt comprises at least one of: displaying the user-defined excerpt in association with the media program; and displaying the user-defined excerpt along with a plurality of other user-defined excerpts associated with other media programs.

In some embodiments, the computer programming instructions are executed to further perform: associating the beginning of the user-defined excerpt with an X point in time of the media program; and associating the end of the user-defined excerpt with a Y point in time of the media program, wherein Y occurs later in time than X; playing, in response to user request, the user-defined excerpt by playing the media program starting from the X point in time and ending at the Y point in time.

In some embodiments, the system includes an analysis module that contains computer hardware encoded with software instructions that when executed, perform: building a database containing a plurality of user-defined excerpts from a plurality of users; analyzing the database to determine a set of media viewing preferences for one or more of the users; making media program recommendations to the one or more users based on the analyzing; and assisting in making media program acquisition or removal decisions for a media program library.

In some embodiments, the computer instructions, when executed, further perform: facilitating a sharing of the user-defined excerpt. The facilitating the sharing may include facilitating the sharing of the user-defined excerpt over a social media network. The facilitating the sharing may include facilitating a transmission, via an electronic message, of the user-defined excerpt or a link thereto to a target recipient.

According to one aspect of the present disclosure, a communications interface for communicating with external entities is disclosed. The communications interface includes: a memory storage component configured to store computer programming code; and a computer processor configured to execute the computer programming code to perform the following: detecting a first electronic access to a media program account of a user; recording a first list of available media programs in the media program account of the user at a time of the first access; detecting a second electronic access to the media program account of the user, wherein the second access occurs after the first access; recording a second list of available media programs in the media program account of the user at a time of the second access; comparing the second list with the first list to identify a third list of available media programs that are in the second list but not in the first list; and communicating, via the communications interface, the third list of available media programs to the user.

In some embodiments, the first list of available media programs and the second list of available media programs each include media programs belonging to a newly-added category of the media program account. In some embodiments, the communicating comprises: in response to a request from the user to view a selection of media programs in the newly-added category, communicating the third list of available media programs separately from other media programs in the newly-added category. In some embodiments, the communicating comprises: in response to a request from the user to view a selection of media programs in the newly-added category, communicating the third list of available media programs before communicating other media programs in the newly-added category. The media programs in the third list may include media programs added to the media program account since the time of the first access.

In some embodiments, the electronic device includes a computer server of a media service provider. In some embodiments, the media programs in the first list, second list, or third list include media programs that are electronically stream-able from the computer server of the media service provider to a user device via a wireless or wired telecommunications protocol.

In some embodiments, the electronic device includes one of: a television set, a laptop, a tablet computer, and a mobile telephone of the user; and the television set, the laptop, the tablet computer, and the mobile telephone are each configured to stream the media programs from a remote server via a wireless or wired telecommunications protocol.

According to one aspect of the present disclosure, a method of displaying media content is disclosed. The method includes: detecting a first electronic access to a media program account of a user; recording, via one or more electronic processors, a first list of available media programs in the media program account of the user at a time of the first access; detecting a second electronic access to the media program account of the user, wherein the second access occurs after the first access; recording, via the one or more electronic processors, a second list of available media programs in the media program account of the user at a time of the second access; comparing the second list with the first list to identify a third list of available media programs that are in the second list but not in the first list; and communicating the third list of available media programs via an electronic device.

In some embodiments, the first list of available media programs and the second list of available media programs each include media programs belonging to a newly-added category of the media program account. In some embodiments, the communicating comprises: in response to a request from the user to view a selection of media programs in the newly-added category, displaying the third list of available media programs separately from displaying other media programs in the newly-added category. In some embodiments, the communicating comprises: in response to a request from the user to view a selection of media programs in the newly-added category, displaying the third list of available media programs before displaying other media programs in the newly-added category. In some embodiments, the media programs in the third list include media programs added to the media program account since the time of the first access.

In some embodiments, the detecting the first electronic access, the recording the first list of media programs, the detecting the second electronic access, the recording the second list of media programs, the comparing, and the displaying are each performed at least in part by one or more computer servers of a media service provider.

In some embodiments, the media programs in the first list, second list, or third list include one of: media programs that are electronically stream-able from an online database via a wireless or wired telecommunications protocol; and media programs that are electronically stored locally on the electronic device.

In some embodiments, the electronic device includes at least one of: a laptop, a television set, a tablet computer, and a mobile telephone each having a screen component for displaying the third list of media programs.

According to one aspect of the present disclosure, a system for playing digital media is disclosed. The system includes: a computer database configured to electronically stores a plurality of media programs each in a digital format; and a user interface module installed on an electronic device located remotely from the computer database, wherein the electronic device is configured to communicate with the computer database via a wireless or wired telecommunications protocol, and wherein the user interface module contains computer programming instructions, that when executed, perform the following tasks: detecting a first electronic access to a media program account of a user; recording a first list of available media programs in the media program account of the user at a time of the first access; detecting a second electronic access to the media program account of the user, wherein the second access occurs after the first access; recording a second list of available media programs in the media program account of the user at a time of the second access; comparing the second list with the first list to identify a third list of available media programs that are in the second list but not in the first list; and displaying the third list of available media programs via the communications interface.

In some embodiments, the first list of available media programs and the second list of available media programs each include media programs belonging to a newly-added category of the media program account. In some embodiments, the displaying comprises: in response to a request from the user to view a selection of media programs in the newly-added category, displaying the third list of available media programs separately from displaying other media programs in the newly-added category. In some embodiments, the displaying comprises: in response to a request from the user to view a selection of media programs in the newly-added category, displaying the third list of available media programs before displaying other media programs in the newly-added category. In some embodiments, the media programs in the third list include media programs added to the media program account since the time of the first access.

In some embodiments, the system is a part of a server of a media service provider. In some embodiments, the media programs in the first list, second list, or third list include media programs that are electronically stream-able from the server of the media service provider to the electronic device via a wireless or wired telecommunications protocol.

According to one aspect of the present disclosure, a method of managing media programs in an account of a user is disclosed. The method includes: displaying, via an electronic device, a media program to a user; detecting, from the user, a tagging of the media program, the tagging including an assignment of a user-defined tag to the media program; associating the user-defined tag with the media program; receiving, from the user, a request to filter a queue of the account of the user, the queue containing a plurality of media programs; and displaying, via the electronic device, a subset of the media programs in the queue, wherein the media programs in the subset are each associated with the user-defined tag.

In some embodiments, the method further includes: collecting a plurality of user-defined tags from a plurality of users; analyzing the plurality of user-defined tags to project viewing preferences for each user individually and for the plurality of users collectively; recommending media programs for each user based on the analyzing; and making media program acquisition and removal decisions based on the analyzing.

In some embodiments, the detecting, the associating, and the receiving are each performed at least in part by one or more computer servers of a media service provider.

In some embodiments, the electronic device is a portable electronic device having a touch screen, and wherein the displaying the media program is performed using the touch screen.

In some embodiments, the user-defined tag includes an interest level of the user with respect to the media program.

In some embodiments, the account of the user contains a plurality of different user profiles; the tagging of the media program originates from one of the user profiles; the associating is performed so that the user-defined tag is associated only with the profile from which the tagging originated.

In some embodiments, the method further includes: maintaining a separate queue for each of the user profiles.

In some embodiments, the media programs are electronically stream-able from an online database via a wireless or wired telecommunications protocol.

In some embodiments, the media programs are electronically stored locally on the electronic device.

It should be appreciated that like reference numerals in the present disclosure are used to identify like elements illustrated in one or more of the figures, wherein these labeled figures are for purposes of illustrating embodiments of the present disclosure and not for purposes of limiting the same.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. An electronic device, comprising:
an electronic user interface component configured to play a media program;
a memory storage component configured to store computer programming code; and
a computer processor component configured to execute the computer programming code to perform the following:
receiving, during a playing of the media program, a first input that defines a beginning of a user-defined excerpt of the media program;
receiving, during the playing of the media program, and after the beginning of the user-defined excerpt of the media program has been defined, a second input that defines an end of the user-defined excerpt of the media program;
associating the user-defined excerpt of the media program with an account of a user; and
thereafter displaying an availability of the user-defined excerpt of the media program.

2. The electronic of claim 1, wherein:
the electronic device includes a portable electronic device with a touch screen display; and
the first input and the second input each include a gesture-based interaction with the touch screen display from the user.

3. The electronic of claim 1, wherein the displaying the availability of the user-defined excerpt comprises at least one of:
displaying the user-defined excerpt in association with the media program; and
displaying the user-defined excerpt along with a plurality of other user-defined excerpts associated with other media programs.

4. The electronic of claim 1, wherein the computer processor component is configured to execute the computer programming code to further perform:
prompting the user to name the user-defined excerpt after the beginning and the end of the user-defined excerpt have been defined; and
receiving a name for the user-defined excerpt in response to user input;
wherein the displaying the availability of the user-defined excerpt comprises displaying at least one of: the name of the user-defined excerpt, and a thumbnail image of a scene from the user-defined excerpt.

5. The electronic of claim 1, wherein the computer processor component is configured to execute the computer programming code to further perform:
associating the beginning of the user-defined excerpt with an X point in time of the media program;
associating the end of the user-defined excerpt with a Y point in time of the media program, wherein Y occurs later in time than X; and
playing, in response to user request, the user-defined excerpt by playing the media program starting from the X point in time and ending at the Y point in time.

6. The electronic of claim 1, wherein:
the media program is stored locally on one of: the electronic device, and a remote server of a service provider; and
the electronic device includes an electronic communications component configured to communicate with the remote server to stream the media program to the electronic device via a telecommunications protocol.

7. A method of managing media playback, comprising:
playing a media program via an electronic device;
receiving, during the playing of the media program, a first input that defines a beginning of a user-defined excerpt of the media program;
receiving, during the playing of the media program, and after the beginning of the user-defined excerpt of the media program has been defined, a second input that defines an end of the user-defined excerpt of the media program;
associating the user-defined excerpt of the media program with an account of a user; and
thereafter displaying an availability of the user-defined excerpt of the media program.

8. The method of claim 7, wherein:
the electronic device includes a portable electronic device with a touch screen display; and
the first input and the second input each include a gesture-based interaction with the touch screen display from the user.

9. The method of claim 7, wherein the displaying the availability of the user-defined excerpt comprises at least one of:
displaying the user-defined excerpt in association with the media program; and
displaying the user-defined excerpt along with a plurality of other user-defined excerpts associated with other media programs.

10. The method of claim 7, further comprising:
prompting the user to name the user-defined excerpt after the beginning and the end of the user-defined excerpt have been defined; and
receiving a name for the user-defined excerpt in response to user input;
wherein the displaying the availability of the user-defined excerpt comprises displaying at least one of: the name of the user-defined excerpt, and a thumbnail image of a scene from the user-defined excerpt.

11. The method of claim 7, further comprising: playing the user-defined excerpt in response to user request.

12. The method of claim 11, further comprising:
associating the beginning of the user-defined excerpt with an X point in time of the media program; and
associating the end of the user-defined excerpt with a Y point in time of the media program, wherein Y occurs later in time than X;
wherein the playing the user-defined excerpt comprises: playing the media program starting from the X point in time and ending at the Y point in time.

13. The method of claim 7, wherein the playing the media program includes one of:
streaming the media program to the electronic device from an online database via a wireless or wired telecommunications protocol; and
playing the media program from a local computer storage of the electronic device.

14. The method of claim 7, further comprising:
building a database containing a plurality of user-defined excerpts from a plurality of users; and
analyzing the database to determine a set of media viewing preferences for one or more of the users.

15. The method of claim 7, further comprising: performing at least one of the following actions based on the analyzing:
making media program recommendations to the one or more users; and
assisting in making media program acquisition or removal decisions for a media program library.

16. A system for managing and playing digital media, comprising:
a computer storage configured to electronically store a plurality of media programs each in a digital format; and
a user interface module installed on an electronic device located remotely from the computer storage, wherein the electronic device is configured to communicate with the computer storage via a wireless or wired telecommunications protocol, and wherein the user interface module contains computer programming instructions, that when executed, perform the following tasks:
receiving, during a playing of one of the media programs stored on the computer storage, a first input that defines a beginning of a user-defined excerpt of the media program;
receiving, during the playing of the media program, and after the beginning of the user-defined excerpt of the media program has been defined, a second input that defines an end of the user-defined excerpt of the media program;
associating the user-defined excerpt of the media program with an account of a user; and
thereafter displaying an availability of the user-defined excerpt of the media program.

17. The system of claim 16, wherein:
the computer storage includes a plurality of computer servers of a media service provider;
the electronic device includes a portable electronic device with a touch screen display; and
the first input and the second input each include a gesture-based interaction with the touch screen display from the user.

18. The system of claim 16, wherein the displaying the availability of the user-defined excerpt comprises at least one of:
displaying the user-defined excerpt in association with the media program; and
displaying the user-defined excerpt along with a plurality of other user-defined excerpts associated with other media programs.

19. The system of claim 16, wherein the computer programming instructions are executed to further perform:
associating the beginning of the user-defined excerpt with an X point in time of the media program; and
associating the end of the user-defined excerpt with a Y point in time of the media program, wherein Y occurs later in time than X;
playing, in response to user request, the user-defined excerpt by playing the media program starting from the X point in time and ending at the Y point in time.

20. The system of claim 16, wherein the system includes an analysis module that contains computer hardware encoded with software instructions that when executed, perform:
building a database containing a plurality of user-defined excerpts from a plurality of users;
analyzing the database to determine a set of media viewing preferences for one or more of the users;
making media program recommendations to the one or more users based on the analyzing; and
assisting in making media program acquisition or removal decisions for a media program library.
